(19) United States
(12) Patent Application Publication
(10) Pub. No.: US 2025/0211765 A1
(43) Pub. Date: Jun. 26, 2025

(54) DECODING DEVICE, ENCODING DEVICE, DECODING METHOD, AND ENCODING METHOD

(71) Applicant: Panasonic Intellectual Property Corporation of America, Torrance, CA (US)

(72) Inventors: Jingying GAO, Singapore (SG); Han Boon TEO, Singapore (SG); Chong Soon LIM, Singapore (SG); Praveen Kumar YADAV, Singapore (SG); Kiyofumi ABE, Osaka (JP); Takahiro NISHI, Nara (JP); Tadamasa TOMA, Osaka (JP)

(21) Appl. No.: 19/074,953

(22) Filed: Mar. 10, 2025

Related U.S. Application Data
(63) Continuation of application No. PCT/JP2023/026891, filed on Jul. 21, 2023.
(60) Provisional application No. 63/407,241, filed on Sep. 16, 2022.

(51) Int. Cl. H04N 19/30; G06V 10/77; G06V 10/82; H04N 19/70

(52) U.S. Cl. CPC H04N 19/30; H04N 19/70; G06V 10/7715; G06V 10/82

(57) ABSTRACT

A decoder includes: circuitry; and a memory connected to the circuitry, in which the circuitry, in operation, generates an image by decoding a bitstream, generates a plurality of intermediate feature maps having a uniform size based on the image, generates, based on the plurality of intermediate feature maps, a plurality of feature maps having different sizes for each hierarchical layer in a plurality of hierarchical layers included in a neural network for a machine task, and in generation of the feature maps, for at least one hierarchical layer of the plurality of hierarchical layers, selects any of: a first method of generating the plurality of feature maps of the at least one hierarchical layer using the plurality of intermediate feature maps, and a second method of generating the plurality of feature maps of the at least one hierarchical layer without using the plurality of intermediate feature maps but using the plurality of feature maps generated in a hierarchical layer different from the at least one hierarchical layer of the plurality of hierarchical layers.

### FIELD OF INVENTION

The present disclosure relates to a decoder, an encoder, a decoding method, and an encoding method.

### BACKGROUND ART

Faster-RCNN is configured to include a first neural network (feature pyramid network) that generates a plurality of feature maps and a second neural network (region proposal network) that extracts a region of interest (ROI) from the feature maps.
Patent Literatures 1 and 2 disclose an object detection method using Faster-RCNN.
Patent Literature 1: Chinese Patent Application Publication No. 109344897
Patent Literature 2: Chinese Patent Application Publication No. 109785333

### SUMMARY OF THE INVENTION

An object of the present disclosure is to reduce a data amount of a bitstream transmitted from an encoder including the first neural network to a decoder including the second neural network.

A decoder according to one aspect of the present disclosure includes: circuitry; and a memory connected to the circuitry, in which the circuitry, in operation, generates an image by decoding a bitstream, generates a plurality of intermediate feature maps having a uniform size based on the image, generates, based on the plurality of intermediate feature maps, a plurality of feature maps having different sizes for each hierarchical layer in a plurality of hierarchical layers included in a neural network for a machine task, and in generation of the feature maps, for at least one hierarchical layer of the plurality of hierarchical layers, selects any of: a first method of generating the plurality of feature maps of the at least one hierarchical layer using the plurality of intermediate feature maps, and a second method of generating the plurality of feature maps of the at least one hierarchical layer without using the plurality of intermediate feature maps but using the plurality of feature maps generated in a hierarchical layer different from the at least one hierarchical layer of the plurality of hierarchical layers.

### BRIEF DESCRIPTION OF THE DRAWINGS

FIG. 1 is a view illustrating, in a simplified manner, a configuration of an image processing system according to an embodiment of the present disclosure.

FIG. 2A is a view illustrating a first configuration example of an information processing unit.

FIG. 2B is a view illustrating a second configuration example of the information processing unit.

FIG. 3 is a flowchart showing a flow of processing executed by the information processing unit.

FIG. 4 is a flowchart showing details of generation processing of an intermediate feature map.

FIG. 5 is a view illustrating a feature map.

FIG. 6 is a view illustrating an intermediate feature map.

FIG. 7 is a view illustrating an intermediate feature map.

FIG. 8 is a view illustrating generation processing of an image by an image generation unit.

FIG. 9 is a view illustrating an example of a data structure of a bitstream.

FIG. 10A is a view illustrating a first example of a data structure of a parameter.

FIG. 10B is a view illustrating the first example of the data structure of the parameter.

FIG. 11A is a view illustrating a second example of a data structure of a parameter.

FIG. 11B is a view illustrating the second example of the data structure of the parameter.

FIG. 12A is a view illustrating a third example of a data structure of a parameter.

FIG. 12B is a view illustrating the third example of the data structure of the parameter.

FIG. 13A is a view illustrating a first configuration example of the information processing unit.

FIG. 13B is a view illustrating a second configuration example of the information processing unit.

FIG. 14 is a flowchart showing a flow of processing executed by the information processing unit.

FIG. 15 is a flowchart showing details of generation processing of a feature map.

FIG. 16A is a view illustrating a third configuration example of the information processing unit.

FIG. 16B is a view illustrating a fourth configuration example of the information processing unit.

FIG. 17 is a view illustrating a configuration of an information processing unit according to a modification.

FIG. 18 is a view illustrating a configuration of an information processing unit according to a modification.

### DETAILED DESCRIPTION

### (Knowledge Underlying Present Disclosure)

Faster-RCNN is known as a model in which a region based convolutional neural network (R-CNN), which is a region-based object detection model is sped up. In Faster-RCNN, a plurality of feature maps having different sizes in each hierarchical layer are generated by performing convolution processing on an input image of a processing target using the first neural network (feature pyramid network) of a plurality of hierarchical layers. Then, by applying the generated feature map with an RP model using the second neural network (region proposal network), an ROI region is extracted from the feature map, and image recognition is performed on the extracted ROI region.

For example, in a surveillance camera system, when processing using the first neural network is performed on the camera side and processing using the second neural network is performed on a server device side, an encoder generates a bitstream by encoding a feature map generated using the first neural network, and transmits the generated bitstream to a decoder. The decoder reconstructs the feature map by decoding the received bitstream, and performs processing using the second neural network on the reconstructed feature map.

However, the data amount of the feature map is enormous as compared with the data amount of an input image of a processing target, and thus there is a problem that the data amount of the bitstream transmitted from the encoder to the decoder also increases.

In order to solve such a problem, focusing on the fact that a plurality of feature maps generated in a plurality of hierarchical layers of the first neural network have strong correlation and include many redundancies, the present inventors have found that the above problem can be solved by omitting encoding of some feature maps depending on the content of an image or a machine task at the time of encoding, and have arrived at the present disclosure.

Next, each aspect of the present disclosure will be described.

A decoder according to a first aspect of the present disclosure includes: circuitry; and a memory connected to the circuitry, in which the circuitry, in operation, generates an image by decoding a bitstream, generates a plurality of intermediate feature maps having a uniform size based on the image, generates, based on the plurality of intermediate feature maps, a plurality of feature maps having different sizes for each hierarchical layer in a plurality of hierarchical layers included in a neural network for a machine task, and in generation of the feature maps, for at least one hierarchical layer of the plurality of hierarchical layers, selects any of: a first method of generating the plurality of feature maps of the at least one hierarchical layer using the plurality of intermediate feature maps, and a second method of generating the plurality of feature maps of the at least one hierarchical layer without using the plurality of intermediate feature maps but using the plurality of feature maps generated in a hierarchical layer different from the at least one hierarchical layer of the plurality of hierarchical layers.

According to the first aspect, for at least one hierarchical layer of the plurality of hierarchical layers included in the neural network, by selecting the first method in the decoder when the encoding of the feature map is not omitted in the encoder and selecting the second method in the decoder when the encoding of the feature map is omitted in the encoder, it is possible to appropriately reconstruct the feature map of the hierarchical layer in the decoder.

In a decoder according to a second aspect of the present disclosure, in the first aspect, preferably, the circuitry, in operation, obtains, from the bitstream a parameter indicating which of the first method and the second method is selected for the at least one hierarchical layer, and in generation of the feature map, selects, based on the parameter, any of the first method and the second method for the at least one hierarchical layer.

According to the second aspect, by transmitting the parameter from the encoder to the decoder, it is possible to dynamically switch which of the first method and the second method to select for each hierarchical layer of the plurality of hierarchical layers.

In a decoder according to a third aspect of the present disclosure, in the second aspect, preferably, the circuitry, in operation, selects any of the first method and the second method for each hierarchical layer of the plurality of hierarchical layers, the parameter includes a plurality of flags corresponding to the plurality of hierarchical layers, and a value of each flag of the plurality of flags indicates which of the first method and the second method to select for a corresponding hierarchical layer.

According to the third aspect, by referring to the value of each flag of the plurality of flags included in the parameter, it is possible to appropriately select the first method or the second method for each hierarchical layer.

In a decoder according to a fourth aspect of the present disclosure, in the second aspect, preferably, the circuitry, in operation, selects any of the first method and the second method for each hierarchical layer of the plurality of hierarchical layers, the parameter includes data of a plurality of bits corresponding to the plurality of hierarchical layers, and a value of each bit of the plurality of bits indicates which of the first method and the second method to select for a corresponding hierarchical layer.

According to the fourth aspect, by referring to the value of each bit of the plurality of bits included in the parameter, it is possible to appropriately select the first method or the second method for each hierarchical layer.

In a decoder according to a fifth aspect of the present disclosure, in the second aspect, preferably, the circuitry, in operation, selects any of the first method and the second method for each hierarchical layer of the plurality of hierarchical layers, a plurality of patterns are defined in advance regarding a combination of which of the first method and the second method to select for each hierarchical layer of the plurality of hierarchical layers, one pattern is selected from among the plurality of patterns, and the parameter includes information specifying the one pattern.

According to the fifth aspect, by referring to the information specifying one pattern included in the parameter, it is possible to appropriately select the first method or the second method for each hierarchical layer.

In a decoder according to a sixth aspect of the present disclosure, in any one of the second to fifth aspects, preferably, the circuitry, in operation, obtains the parameter by decoding a supplemental enhancement information (SEI) region of the bitstream.

According to the sixth aspect, by decoding the SEI region of the bitstream, it is possible to easily obtain the parameter.

In a decoder according to a seventh aspect of the present disclosure, in any one of the first to sixth aspects, preferably, when the first method is selected for the at least one hierarchical layer, the circuitry, in operation, generates the plurality of feature maps of the hierarchical layer using the plurality of intermediate feature maps and the plurality of feature maps generated in a hierarchical layer different from the hierarchical layer among the plurality of hierarchical layers.

According to the seventh aspect, when the first method is selected for at least one hierarchical layer, by using the plurality of intermediate feature maps and the plurality of feature maps generated in a hierarchical layer different from the hierarchical layer among the plurality of hierarchical layers, it is possible to appropriately generate the plurality of feature maps of the hierarchical layer.

In a decoder according to an eighth aspect of the present disclosure, in any one of the first to seventh aspects, preferably, a size of the intermediate feature map is equal to a size of a feature map having a smallest size among the plurality of feature maps generated in the plurality of hierarchical layers, and when the first method is selected for the at least one hierarchical layer, the circuitry, in operation, enlarges the size of the intermediate feature map to a size of a feature map generated in the at least one hierarchical layer.

According to the eighth aspect, when the first method is selected for at least one hierarchical layer, by enlarging the size of the intermediate feature map, it is possible to appropriately generate the plurality of feature maps of the hierarchical layer.

In a decoder according to a ninth aspect of the present disclosure, in any one of the first to seventh aspects, preferably, a size of the intermediate feature map is equal to a size of a feature map having a largest size among the plurality of feature maps generated in the plurality of hierarchical layers, and when the first method is selected for the at least one hierarchical layer, the circuitry, in operation, reduces the size of the intermediate feature map to a size of a feature map generated in the at least one hierarchical layer.

According to the ninth aspect, when the first method is selected for at least one hierarchical layer, by reducing the size of the intermediate feature map, it is possible to appropriately generate the plurality of feature maps of the hierarchical layer.

In a decoder according to a 10th aspect of the present disclosure, in any one of the first to ninth aspects, preferably, when the first method is selected for the at least one hierarchical layer, the circuitry, in operation, generates the plurality of feature maps whose number is larger than the number of the plurality of intermediate feature maps by performing convolution processing on the plurality of intermediate feature maps.

According to the 10th aspect, when the first method is selected for at least one hierarchical layer, by performing the convolution processing on the plurality of intermediate feature maps, it is possible to appropriately generate the plurality of feature maps whose number is larger than the number of the plurality of intermediate feature maps.

In a decoder according to an 11th aspect of the present disclosure, in any one of the first to ninth aspects, preferably, when the first method is selected for the at least one hierarchical layer, the circuitry, in operation, generates the plurality of feature maps whose number is smaller than the number of the plurality of intermediate feature maps by extracting two or more intermediate feature maps corresponding to the at least one hierarchical layer from the plurality of intermediate feature maps.

According to the 11th aspect, by transmitting, from the encoder to the decoder, the plurality of intermediate feature maps including two or more intermediate feature maps corresponding to the respective hierarchical layers of the plurality of hierarchical layers and extracting the two or more intermediate feature maps corresponding to the respective hierarchical layers from the plurality of intermediate feature maps in the decoder, it is possible to appropriately generate the feature map corresponding to each hierarchical layer based on the two or more intermediate feature maps.

In a decoder according to a 12th aspect of the present disclosure, in any one of the first to 11th aspects, preferably, the circuitry, in operation, selects any of the first method and the second method for each hierarchical layer of the plurality of hierarchical layers, and a number of the plurality of intermediate feature maps is smaller as a number of hierarchical layers for selecting the second method among the plurality of hierarchical layers is larger.

According to the 12th aspect, since the number of the plurality of intermediate feature maps is smaller as the number of hierarchical layers for selecting the second method among the plurality of hierarchical layers is larger, it is possible to reduce the data amount of the bitstream transmitted from the encoder to the decoder.

In a decoder according to a 13th aspect of the present disclosure, in any one of the first to 12th aspects, preferably, the circuitry, in operation, selects any of the first method and the second method for each hierarchical layer of the plurality of hierarchical layers, and when a size of an object of a detection target in the machine task is less than a threshold, or when local information is required in the machine task, the second method is selected for at least a hierarchical layer having the smallest size of a generated feature map among the plurality of hierarchical layers.

According to the 13th aspect, when the size of the object of a detection target in the machine task is less than a threshold, or when local information is required in the machine task, by selecting the second method for at least a hierarchical layer having the smallest size of a generated feature map among the plurality of hierarchical layers, it is possible to reduce the data amount of the bitstream transmitted from the encoder to the decoder while leaving information necessary for the machine task.

In a decoder according to a 14th aspect of the present disclosure, in any one of the first to 12th aspects, preferably, the circuitry, in operation, selects any of the first method and the second method for each hierarchical layer of the plurality of hierarchical layers, and when a size of an object of a detection target in the machine task is equal to or greater than a threshold, or when global information is required in the machine task, the second method is selected for at least a hierarchical layer having the largest size of a generated feature map among the plurality of hierarchical layers.

According to the 14th aspect, when the size of the object of a detection target in the machine task is equal to or greater than a threshold, or when global information is required in the machine task, by selecting the second method for at least a hierarchical layer having the largest size of a generated feature map among the plurality of hierarchical layers, it is possible to reduce the data amount of the bitstream transmitted from the encoder to the decoder while leaving information necessary for the machine task.

An encoder according to a 15th aspect of the present disclosure includes: circuitry; and a memory connected to the circuitry, in which the circuitry in operation, generates, based on an input image of a processing target, a plurality of feature maps having different sizes for each hierarchical layer in a plurality of hierarchical layers included in a neural network for a machine task, generates a plurality of intermediate feature maps having a uniform size based on a plurality of feature maps generated in the plurality of hierarchical layers, generates an image based on the plurality of intermediate feature maps, generates a bitstream by encoding the image, and in generation of the intermediate feature maps, for at least one hierarchical layer of the plurality of hierarchical layers, selects any of: a first method of generating the plurality of intermediate feature maps using the plurality of feature maps generated in the at least one hierarchical layer, and a second method of generating the plurality of intermediate feature maps without using the plurality of feature maps generated in the at least one hierarchical layer.

According to the 15th aspect, for at least one hierarchical layer of the plurality of hierarchical layers included in the neural network, any of the first method of generating the plurality of intermediate feature maps using the plurality of feature maps generated in the hierarchical layer and the second method of generating the plurality of intermediate feature maps not using the plurality of feature maps generated in the hierarchical layer is selected. When the second method is selected for the hierarchical layer, it is possible to omit encoding of the plurality of intermediate feature maps for the hierarchical layer, and therefore it is possible to reduce the data amount of the bitstream transmitted from the encoder to the decoder.

In an encoder according to a 16th aspect of the present disclosure, in the 15th aspect, preferably, the circuitry, in operation, generates the bitstream including a parameter indicating which of the first method and the second method to have been selected for the at least one hierarchical layer.

According to the 16th aspect, by transmitting the parameter from the encoder to the decoder, it is possible to dynamically switch which of the first method and the second method to select for each hierarchical layer of the plurality of hierarchical layers.

In an encoder according to a 17th aspect of the present disclosure, in the 16th aspect, preferably, the circuitry, in operation, selects any of the first method and the second method for each hierarchical layer of the plurality of hierarchical layers, the parameter includes a plurality of flags corresponding to the plurality of hierarchical layers, and a value of each flag of the plurality of flags indicates which of the first method and the second method to have been selected for a corresponding hierarchical layer.

According to the 17th aspect, by the value of each flag of the plurality of flags included in the parameter, it is possible to clearly indicate which one of the first method and the second method to have been selected for each hierarchical layer.

In an encoder according to an 18th aspect of the present disclosure, in the 16th aspect, preferably, the circuitry, in operation, selects any of the first method and the second method for each hierarchical layer of the plurality of hierarchical layers, the parameter includes data of a plurality of bits corresponding to the plurality of hierarchical layers, and a value of each bit of the plurality of bits indicates which of the first method and the second method to have been selected for a corresponding hierarchical layer.

According to the 18th aspect, by the value of each bit of the plurality of bits included in the parameter, it is possible to clearly indicate which one of the first method and the second method to have been selected for each hierarchical layer.

In an encoder according to a 19th aspect of the present disclosure, in the 16th aspect, preferably, the circuitry, in operation, selects any of the first method and the second method for each hierarchical layer of the plurality of hierarchical layers, a plurality of patterns are defined in advance regarding a combination of which of the first method and the second method to select for each hierarchical layer of the plurality of hierarchical layers, one pattern is selected from among the plurality of patterns, and the parameter includes information specifying the one pattern.

According to the 19th aspect, by the information specifying one pattern included in the parameter, it is possible to clearly indicate which one of the first method and the second method to have been selected for each hierarchical layer.

In an encoder according to a 20th aspect of the present disclosure, in any one of the 16th to 19th aspects, preferably, the circuitry, in operation, stores the parameter in a supplemental enhancement information (SEI) region of the bitstream.

According to the 20th aspect, by storing the parameter into the SEI region of the bitstream, it is possible to easily decode the parameter in the decoder.

In an encoder according to a 21st aspect of the present disclosure, in any one of the 15th to 20th aspects, preferably, a size of the intermediate feature map is equal to a size of a feature map having a smallest size among the plurality of feature maps generated in the plurality of hierarchical layers, and when the first method is selected for the at least one hierarchical layer, the circuitry, in operation, reduces a size of a feature map generated in the at least one hierarchical layer to a size of the intermediate feature map.

According to the 21st aspect, when the first method is selected for at least one hierarchical layer, by reducing the size of the feature map, it is possible to appropriately generate the plurality of intermediate feature maps of the hierarchical layer.

In an encoder according to a 22nd aspect of the present disclosure, in any one of the 15th to 20th aspects, preferably, a size of the intermediate feature map is equal to a size of a feature map having a largest size among the plurality of feature maps generated in the plurality of hierarchical layers, and when the first method is selected for the at least one hierarchical layer, the circuitry, in operation, enlarges a size of a feature map generated in the at least one hierarchical layer to a size of the intermediate feature map.

According to the 22nd aspect, when the first method is selected for at least one hierarchical layer, by enlarging the size of the feature map, it is possible to appropriately generate the plurality of intermediate feature maps of the hierarchical layer.

In an encoder according to a 23rd aspect of the present disclosure, in any one of the 15th to 22nd aspects, preferably, the circuitry, in operation, selects any of the first method and the second method for each hierarchical layer of the plurality of hierarchical layers, and a number of the plurality of intermediate feature maps is smaller as a number of hierarchical layers in which the second method among the plurality of hierarchical layers is selected is larger.

According to the 23rd aspect, since the number of the plurality of intermediate feature maps is smaller as a number of hierarchical layers in which the second method among the plurality of hierarchical layers is selected is larger, it is possible to reduce the data amount of the bitstream transmitted from the encoder to the decoder.

In an encoder according to a 24th aspect of the present disclosure, in any one of the 15th to 23rd aspects, preferably, the circuitry, in operation, selects any of the first method and the second method for each hierarchical layer of the plurality of hierarchical layers, and when a size of an object of a detection target in the machine task is less than a threshold, or when local information is required in the machine task, the second method is selected for at least a hierarchical layer having a smallest size of a generated feature map among the plurality of hierarchical layers.

According to the 24th aspect, when the size of the object of a detection target in the machine task is less than a threshold, or when local information is required in the machine task, by selecting the second method for at least a hierarchical layer having the smallest size of a generated feature map among the plurality of hierarchical layers, it is possible to reduce the data amount of the bitstream transmitted from the encoder to the decoder while leaving information necessary for the machine task.

In an encoder according to a 25th aspect of the present disclosure, in any one of the 15th to 22nd aspects, the circuitry, in operation, selects any of the first method and the second method for each hierarchical layer of the plurality of hierarchical layers, and when a size of an object of a detection target in the machine task is equal to or greater than a threshold, or when global information is required in the machine task, the second method is selected for at least a hierarchical layer having a largest size of a generated feature map among the plurality of hierarchical layers.

According to the 25th aspect, when the size of the object of a detection target in the machine task is equal to or greater than a threshold, or when global information is required in the machine task, by selecting the second method for at least a hierarchical layer having the largest size of a generated feature map among the plurality of hierarchical layers, it is possible to reduce the data amount of the bitstream transmitted from the encoder to the decoder while leaving information necessary for the machine task.

In a decoding method according to a 26th aspect of the present disclosure, a decoder generates an image by decoding a bitstream, generates a plurality of intermediate feature maps having a uniform size based on the image, generates, based on the plurality of intermediate feature maps, a plurality of feature maps having different sizes for each hierarchical layer in a plurality of hierarchical layers included in a neural network for a machine task, and in generation of the feature maps, for at least one hierarchical layer of the plurality of hierarchical layers, selects any of: a first method of generating the plurality of feature maps of the at least one hierarchical layer using the plurality of intermediate feature maps, and a second method of generating the plurality of feature maps of the at least one hierarchical layer without using the plurality of intermediate feature maps but using the plurality of feature maps generated in a hierarchical layer different from the at least one hierarchical layer of the plurality of hierarchical layers.

According to the 26th aspect, for at least one hierarchical layer of the plurality of hierarchical layers included in the neural network, by selecting the first method in the decoder when the encoding of the feature map is not omitted in the encoder and selecting the second method in the decoder when the encoding of the feature map is omitted in the encoder, it is possible to appropriately reconstruct the feature map of the hierarchical layer in the decoder.

In an encoding method according to a 27th aspect of the present disclosure, an encoder generates, based on an input image of a processing target, a plurality of feature maps having different sizes for each hierarchical layer in a plurality of hierarchical layers included in a neural network for a machine task, generates a plurality of intermediate feature maps having a uniform size based on a plurality of feature maps generated in the plurality of hierarchical layers, generates an image based on the plurality of intermediate feature maps, generates a bitstream by encoding the image, and in generation of the intermediate feature maps, for at least one hierarchical layer of the plurality of hierarchical layers, selects any of: a first method of generating the plurality of intermediate feature maps using the plurality of feature maps generated in the at least one hierarchical layer, and a second method of generating the plurality of intermediate feature maps without using the plurality of feature maps generated in the at least one hierarchical layer.

According to the 27th aspect, for at least one hierarchical layer of the plurality of hierarchical layers included in the neural network, any of the first method of generating the plurality of intermediate feature maps using the plurality of feature maps generated in the hierarchical layer and the second method of generating the plurality of intermediate feature maps not using the plurality of feature maps generated in the hierarchical layer is selected. When the second method is selected for the hierarchical layer, it is possible to omit encoding of the plurality of intermediate feature maps for the hierarchical layer, and therefore it is possible to reduce the data amount of the bitstream transmitted from the encoder to the decoder.

### Embodiments of Present Disclosure

Embodiments of the present disclosure will be described below in detail with reference to the drawings. Elements denoted with the same reference symbol in different drawings represent the same or corresponding elements.

Note that each embodiment described below shows one specific example of the present disclosure. The numerical values, shapes, constituent elements, steps, orders of the steps, and the like of the following embodiments are merely examples, and do not intend to limit the present disclosure. A constituent element not described in an independent claim representing the highest concept among constituent elements in the embodiments below is described as an arbitrary constituent element. In all embodiments, respective items of content can be combined.

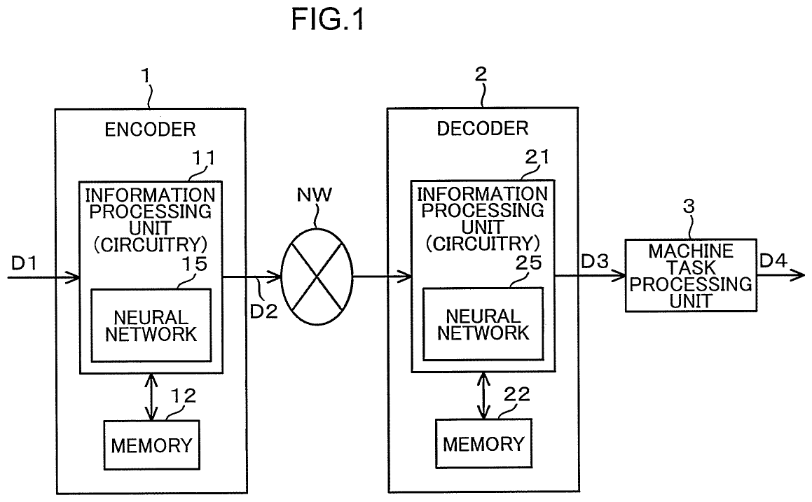

FIG. 1 is a view illustrating, in a simplified manner, the configuration of an image processing system according to an embodiment of the present disclosure. The image processing system includes an encoder 1, a transmission channel NW, a decoder 2, and a machine task processing unit 3.

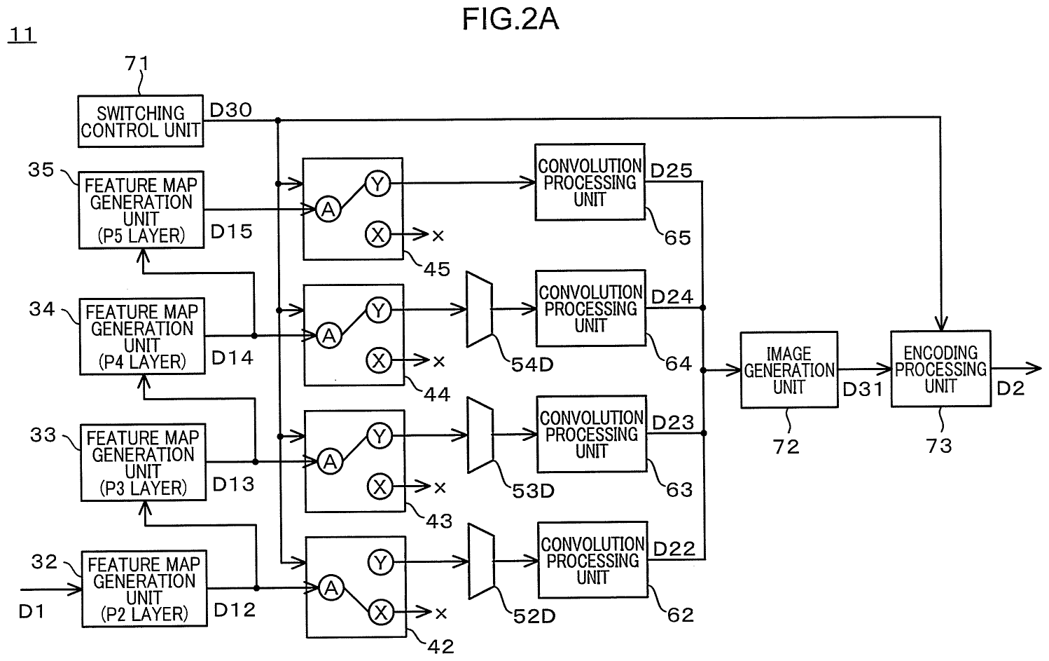

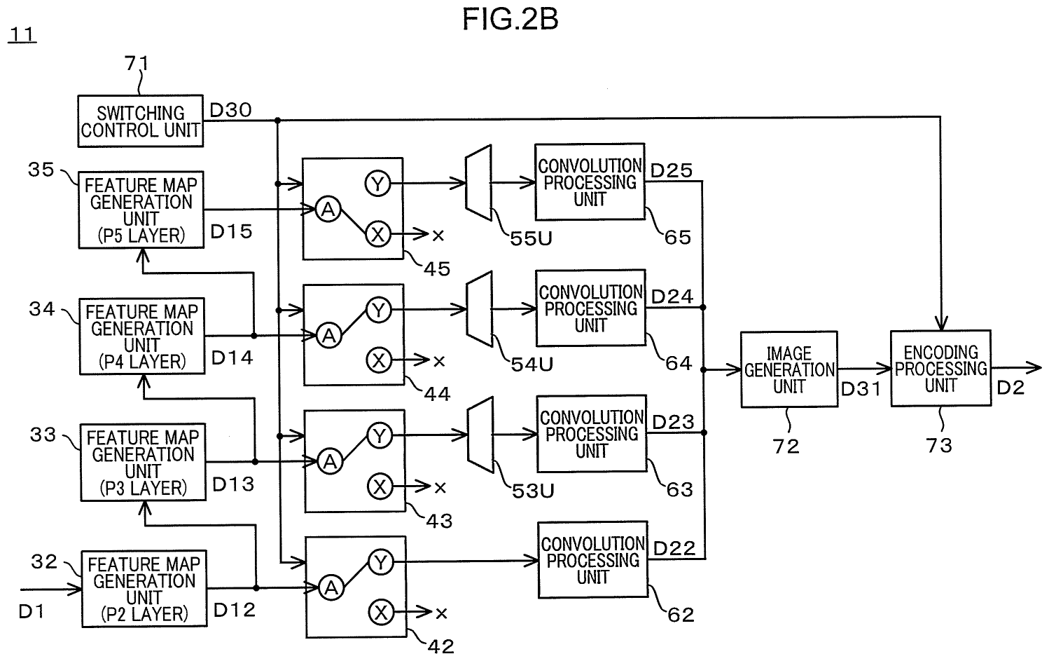

The encoder 1 is configured to include an information processing unit 11 and a memory 12 connected to the information processing unit 11. However, the memory 12 may be included in the information processing unit 11. The information processing unit 11 is circuitry that performs various types of information processing, and includes a processor such as a CPU or a GPU. The information processing includes processing using a neural network 15 for a machine task executed by the machine task processing unit 3. The neural network 15 includes, for example, a first neural network (feature pyramid network) for generating a plurality of feature maps in Faster-RCNN. The memory 12 includes a semiconductor memory such as a ROM or a RAM, a magnetic disk, or an optical disk. The memory 12 stores information necessary for the processor to execute processing. For example, the memory 12 stores an input image D1 of a processing target. The memory 12 stores programs. By the processor executing a program read from the memory 12, the processor functions as each processing unit illustrated in FIGS. 2A and 2B described later. The encoder 1 generates a bitstream D2 based on the input image D1, and transmits the bitstream D2 that is generated to the decoder 2 via the transmission channel NW. Details of the processing content executed by the encoder 1 will be described later.

The transmission channel NW is the Internet, a wide area network (WAN), a local area network (LAN), or an arbitrary combination of them. The transmission channel NW may be a public network or the like, or may be a private network in which secure communication is ensured by access restriction. The transmission channel NW is not necessarily limited to a bidirectional communication network, and may be a unidirectional communication network for transmitting a broadcast wave such as terrestrial digital broadcasting or satellite broadcasting. The transmission channel NW may be a recording medium such as a digital versatile disc (DVD) or a blue-ray disc (BD) on which the bitstream D2 is recorded.

The decoder 2 is configured to include an information processing unit 21 and a memory 22 connected to the information processing unit 21. However, the memory 22 may be included in the information processing unit 21. The information processing unit 21 is circuitry that performs various types of information processing, and includes a processor such as a CPU or a GPU. The information processing includes processing using a neural network 25 for a machine task executed by the machine task processing unit 3. The neural network 25 includes, for example, a second neural network (region proposal network) for extracting a region of interest

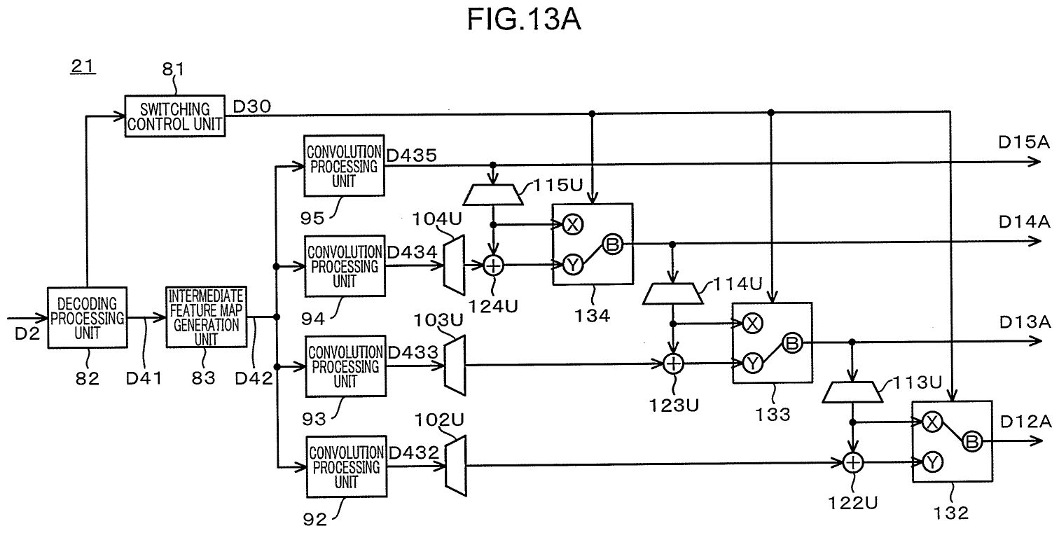

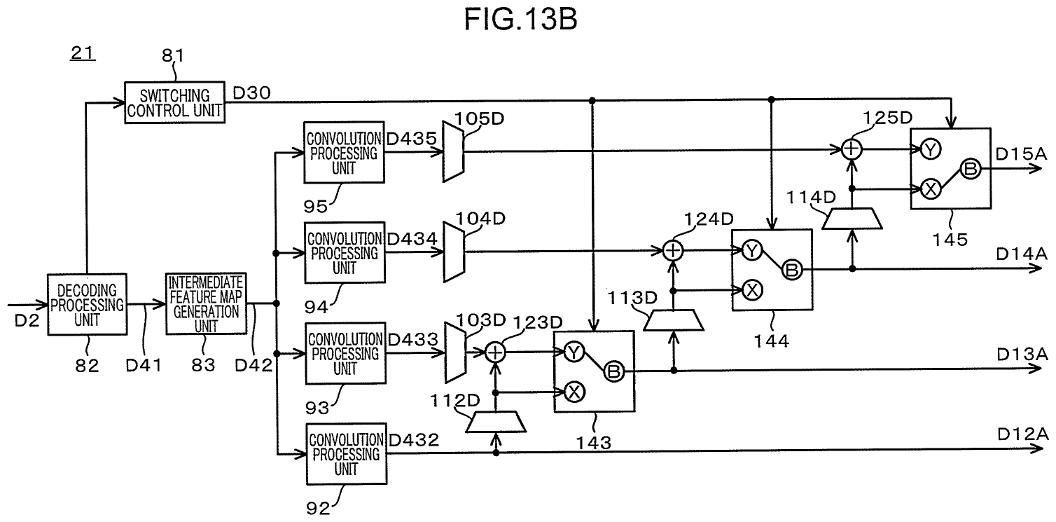

(ROI) in Faster-RCNN. The memory 22 includes a semiconductor memory such as a ROM or a RAM, a magnetic disk, or an optical disk. The memory 22 stores information necessary for the processor to execute processing. For example, the memory 22 stores the bitstream D2 received from the encoder 1. The memory 22 stores programs. By the processor executing a program read from the memory 22, the processor functions as each processing unit illustrated in FIGS. 13A and 13B described later. The decoder 2 reconstructs a plurality of feature maps based on the bitstream D2 received from the encoder 1, and inputs, to the machine task processing unit 3, data D3 including the plurality of feature maps that are reconstructed. Details of the processing content executed by the decoder 2 will be described later.

The machine task processing unit 3 executes a machine task based on the data D3 input from the decoder 2, and outputs data D4 including an inference result of the machine task and the like. The machine task includes, for example, object detection, object segmentation, object tracking, action recognition, or pose estimation.

### (Configuration and Processing of Encoding Device 1)

FIG. 2A is a view illustrating the first configuration example of the information processing unit 11. FIG. 2A illustrates an example of a case where the sizes of a plurality of intermediate feature maps D22 to D25 having uniform sizes are equal to the size of a feature map D15 having the smallest size among a plurality of feature maps D12 to D15 generated in a plurality of hierarchical layers of a P2 layer to a P5 layer.

The information processing unit 11 includes the neural network 15 including the four hierarchical layers of the P2 layer to the P5 layer. However, the number of hierarchical layers included in the neural network 15 is not limited to 4, and may be 2 or more. Specifically, the information processing unit 11 includes feature map generation units 32 to 35, switching processing units 42 to 45, downsampling units 52D to 54D, convolution processing units 62 to 65, a switching control unit 71, an image generation unit 72, and an encoding processing unit 73. Note that for example, for the P3 layer and the P4 layer, which are intermediate hierarchical layers, outputs of the feature map generation units 33 and 34 and inputs of the downsampling units 53D and 54D may be directly connected by omitting mounting of the switching processing units 43 and 44.

The feature map generation unit 32, the switching processing unit 42, the downsampling unit 52D, and the convolution processing unit 62 correspond to the P2 layer, which is the lowest layer. The feature map generation unit 33, the switching processing unit 43, the downsampling unit 53D, and the convolution processing unit 63 correspond to the P3 layer, which is higher by one hierarchical layer than the P2 layer. The feature map generation unit 34, the switching processing unit 44, the downsampling unit 54D, and the convolution processing unit 64 correspond to the P4 layer, which is higher by one hierarchical layer than the P3 layer. The feature map generation unit 35, the switching processing unit 45, and the convolution processing unit 65 correspond to the P5 layer, which is the highest layer.

The switching processing units 42 to 45 include a terminal A on the input side and a terminal X and a terminal Y on the output side, and select and connect one of the terminal X and the terminal Y to the terminal A based on a parameter D30 input from the switching control unit 71. In the example illustrated in FIG. 2A, the switching processing unit 42 connects the terminal X to the terminal A, and the switching processing units 43 to 45 connect the terminal Y to the terminal A. The switching control unit 71 sets the parameter D30 based on setting information input by a user operation, setting information obtained from an analysis result of the input image D1, or setting information input from the machine task processing unit 3.

For example, when the size of the object of a detection target in the machine task executed by the machine task processing unit 3 is equal to or greater than a predetermined threshold, or when global information is required in the machine task executed by the machine task processing unit 3, the switching control unit 71 connects the terminal X to the terminal A for at least the P2 layer having the largest size of the generated feature map among the P2 layer to the P5 layer. In this case, the feature map D12 generated by the feature map generation unit 32 is discarded, and the feature map D12 is not input to the downsampling unit 52D. Note that the switching control unit 71 may connect the terminal X to the terminal A not only for one hierarchical layer of the P2 layer but also for the two hierarchical layers of the P2 layer and the P3 layer or the three hierarchical layers of the P2 layer to the P4 layer. As another example, when the processing bit rate of the encoder 1 or the decoder 2 is lower than a threshold value, when the communication bit rate of the transmission channel NW is lower than a threshold value, or when the inference accuracy of the machine task executed by the machine task processing unit 3 is lower than a threshold value, the terminal X may be connected to the terminal A at least in the P2 layer, which is the lowest layer.

FIG. 2B is a view illustrating the second configuration example of the information processing unit 11. FIG. 2B illustrates an example of a case where the sizes of the plurality of intermediate feature maps D22 to D25 having uniform sizes are equal to the size of the feature map D12 having the largest size among the plurality of feature maps D12 to D15 generated in the plurality of hierarchical layers of the P2 layer to the P5 layer.

The information processing unit 11 includes the neural network 15 including the four hierarchical layers of the P2 layer to the P5 layer. However, the number of hierarchical layers included in the neural network 15 is not limited to 4, and may be 2 or more. Specifically, the information processing unit 11 includes the feature map generation units 32 to 35, the switching processing units 42 to 45, upsampling units 53U to 55U, the convolution processing units 62 to 65, the switching control unit 71, the image generation unit 72, and the encoding processing unit 73. Note that for example, for the P3 layer and the P4 layer, which are intermediate hierarchical layers, outputs of the feature map generation units 33 and 34 and inputs of the upsampling units 53U and 54U may be directly connected by omitting mounting of the switching processing units 43 and 44.

The feature map generation unit 32, the switching processing unit 42, and the convolution processing unit 62 correspond to the P2 layer, which is the lowest layer. The feature map generation unit 33, the switching processing unit 43, the upsampling unit 53U, and the convolution processing unit 63 correspond to the P3 layer, which is higher by one hierarchical layer than the P2 layer. The feature map generation unit 34, the switching processing unit 44, the upsampling unit 54U, and the convolution processing unit 64 correspond to the P4 layer, which is higher by one hierarchical layer than the P3 layer. The feature map generation unit 35, the switching processing unit 45, the upsampling unit 55U, and the convolution processing unit 65 correspond to the P5 layer, which is the highest layer.

The switching processing units 42 to 45 include the terminal A on the input side and the terminal X and the terminal Y on the output side, and select and connect one of the terminal X and the terminal Y to the terminal A based on the parameter D30 input from the switching control unit 71. In the example illustrated in FIG. 2B, the switching processing units 42 to 44 connect the terminal Y to the terminal A, and the switching processing unit 45 connects the terminal X to the terminal A. The switching control unit 71 sets the parameter D30 based on setting information input by a user operation, setting information obtained from an analysis result of the input image D1, or setting information input from the machine task processing unit 3.

For example, when the size of the object of a detection target in the machine task executed by the machine task processing unit 3 is less than the predetermined threshold, or when local information is required in the machine task executed by the machine task processing unit 3, the switching control unit 71 connects the terminal X to the terminal A for at least the P5 layer having the smallest size of the generated feature map among the P2 layer to the P5 layer. In this case, the feature map D15 generated by the feature map generation unit 35 is discarded, and the feature map D15 is not input to the upsampling unit 55U. Note that the switching control unit 71 may connect the terminal X to the terminal A not only for one hierarchical layer of the P5 layer but also for the two hierarchical layers of the P4 layer and the P5 layer or the three hierarchical layers of the P3 layer to the P5 layer.

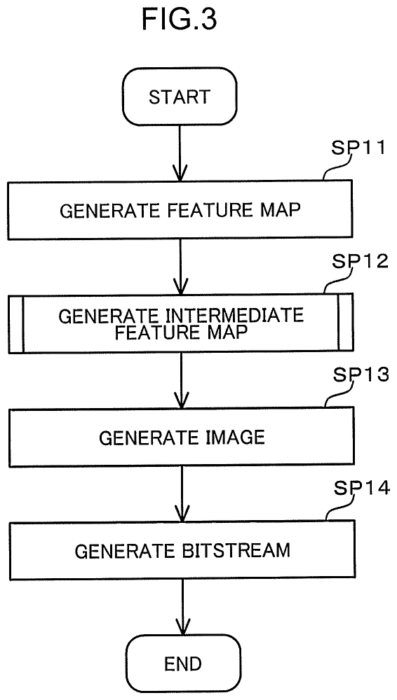

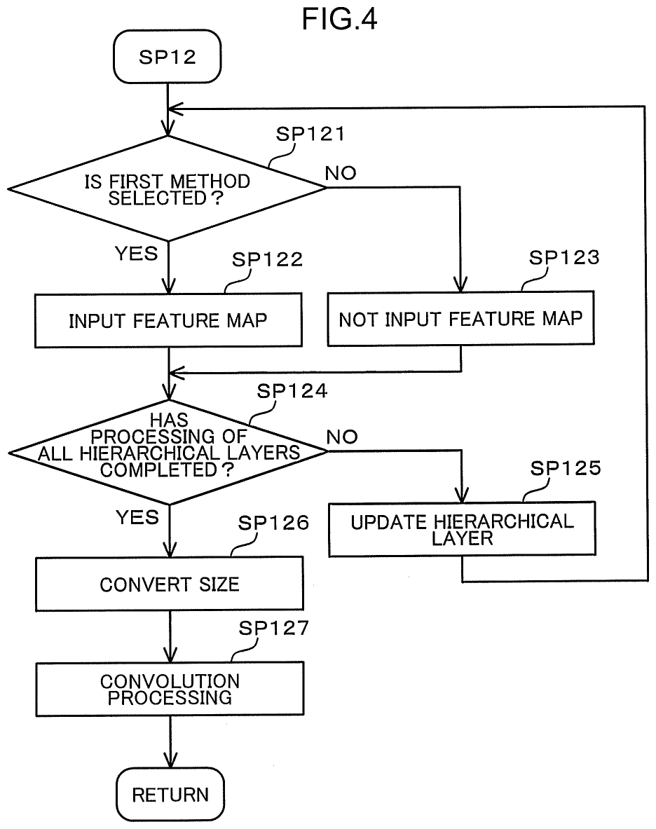

FIG. 3 is a flowchart showing the flow of the processing executed by the information processing unit 11. FIG. 4 is a flowchart showing details of generation processing (step SP12) of an intermediate feature map executed as a subroutine.

First in step SP11, the feature map generation units 32 to 35 generate the feature maps D12 to D15 based on the input image D1.

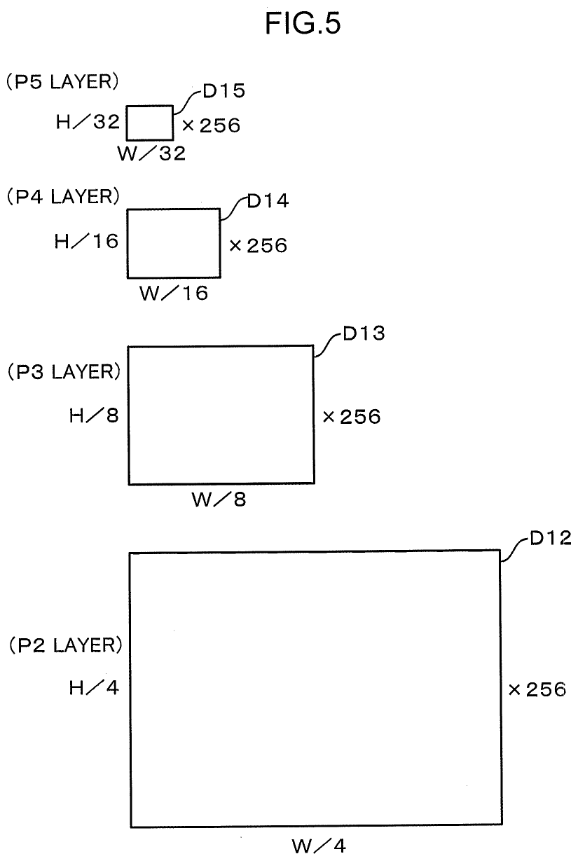

FIG. 5 is a view illustrating the feature maps D12 to D15. First, the feature map generation unit 32 generates, for example, 256 feature maps D12 by performing convolution processing using a predetermined filter on the input image D1. Assuming that the horizontal size of the input image D1 is W and the vertical size is H, the horizontal size of the feature map D12 is W/4 and the vertical size is H/4. Next, the feature map generation unit 33 generates, for example, 256 feature maps D13 by performing convolution processing using a predetermined filter on the feature map D12. The horizontal size of the feature map D13 is W/8, and the vertical size is H/8. Next, the feature map generation unit 34 generates, for example, 256 feature maps D14 by performing convolution processing using a predetermined filter on the feature map D13. The horizontal size of the feature map D14 is W/16, and the vertical size is H/16. Next, the feature map generation unit 35 generates, for example, 256 feature maps D15 by performing convolution processing using a predetermined filter on the feature map D14. The horizontal size of the feature map D15 is W/32, and the vertical size is H/32. The feature map generation units 32 to 35 input the feature maps D12 to D15 that are generated to the terminal A of the switching processing units 42 to 45.

Next in step SP12, the intermediate feature maps D22 to D25 are generated using the processing flow shown in FIG. 4 based on the feature maps D12 to D15 and the parameter D30.

Specifically, first in step SP121, the switching processing unit 42 determines whether the first method is selected (i.e., the terminal Y is selected) or the second method is selected (i.e., the terminal X is selected) for the P2 layer based on the parameter D30. The first method is a method of using the feature map D12 in generation of the intermediate feature maps D22 to D25, and the second method is a method of not using the feature map D12 in generation of the intermediate feature maps D22 to D25. If the first method is selected for the P2 layer (step SP121: YES), next in step SP122, the switching processing unit 42 inputs the feature map D12 to a subsequent processing unit (the downsampling unit 52D in FIG. 2A or the convolution processing unit 62 in FIG. 2B) by connecting the terminal Y to the terminal A. If the second method is selected for the P2 layer (step SP121: NO), next in step SP123, the switching processing unit 42 does not input the feature map D12 to the subsequent processing unit by connecting the terminal X to the terminal A.

Next in step SP124, it is determined whether or not the processing of steps SP121 to SP123 has been completed for all the hierarchical layers of the P2 layer to the P5 layer.

If there is an unprocessed hierarchical layer (step SP124: NO), the hierarchical layer is updated from the P2 layer to the P3 layer in step SP125, and then in step SP121, the switching processing unit 43 determines whether the first method is selected or the second method is selected for the P3 layer based on the parameter D30. The first method is a method of using the feature map D13 in generation of the intermediate feature maps D22 to D25, and the second method is a method of not using the feature map D13 in generation of the intermediate feature maps D22 to D25. If the first method is selected for the P3 layer (step SP121: YES), next in step SP122, the switching processing unit 43 inputs the feature map D13 to a subsequent processing unit (the downsampling unit 53D in FIG. 2A or the upsampling unit 53U in FIG. 2B) by connecting the terminal Y to the terminal A. If the second method is selected for the P3 layer (step SP121: NO), next in step SP123, the switching processing unit 43 does not input the feature map D13 to the subsequent processing unit by connecting the terminal X to the terminal A.

Next in step SP124, it is determined whether or not the processing of steps SP121 to SP123 has been completed for all the hierarchical layers of the P2 layer to the P5 layer.

If there is an unprocessed hierarchical layer (step SP124: NO), the hierarchical layer is updated from the P3 layer to the P4 layer in step SP125, and then in step SP121, the switching processing unit 44 determines whether the first method is selected or the second method is selected for the P4 layer based on the parameter D30. The first method is a method of using the feature map D14 in generation of the intermediate feature maps D22 to D25, and the second method is a method of not using the feature map D14 in generation of the intermediate feature maps D22 to D25. If the first method is selected for the P4 layer (step SP121: YES), next in step SP122, the switching processing unit 44 inputs the feature map D14 to a subsequent processing unit (the downsampling unit 54D in FIG. 2A or the upsampling unit 54U in FIG. 2B) by connecting the terminal Y to the terminal A. If the second method is selected for the P4 layer (step SP121: NO), next in step SP123, the switching processing unit 44 does not input the feature map D14 to the subsequent processing unit by connecting the terminal X to the terminal A.

Next in step SP124, it is determined whether or not the processing of steps SP121 to SP123 has been completed for all the hierarchical layers of the P2 layer to the P5 layer.

If there is an unprocessed hierarchical layer (step SP124: NO), the hierarchical layer is updated from the P4 layer to the P5 layer in step SP125, and then in step SP121, the switching processing unit 45 determines whether the first method is selected or the second method is selected for the P5 layer based on the parameter D30. The first method is a method of using the feature map D15 in generation of the intermediate feature maps D22 to D25, and the second method is a method of not using the feature map D15 in generation of the intermediate feature maps D22 to D25. If the first method is selected for the P5 layer (step SP121: YES), next in step SP122, the switching processing unit 45 inputs the feature map D15 to a subsequent processing unit (the convolution processing unit 65 in FIG. 2A or the upsampling unit 55U in FIG. 2B) by connecting the terminal Y to the terminal A. If the second method is selected for the P5 layer (step SP121: NO), next in step SP123, the switching processing unit 45 does not input the feature map D15 to the subsequent processing unit by connecting the terminal X to the terminal A.

If there is no unprocessed hierarchical layer (step SP124: YES), next in step SP126, size conversion processing for adjusting the sizes of the feature maps D12 to D15 to the sizes of the intermediate feature maps D22 to D25 is performed, and thereafter, in step SP127, convolution processing for reducing the number of the intermediate feature maps D22 to D25 to be smaller than the number of the feature maps D12 to D15 is performed. Note that the size conversion processing in step SP126 is omitted for the P5 layer in FIG. 2A not provided with the downsampling units 52D to 54D and the P2 layer in FIG. 2B not provided with the upsampling units 53U to 55U. The size conversion processing in step SP126 and the convolution processing in step SP127 are omitted for the hierarchical layer in which the second method is selected by the parameter D30.

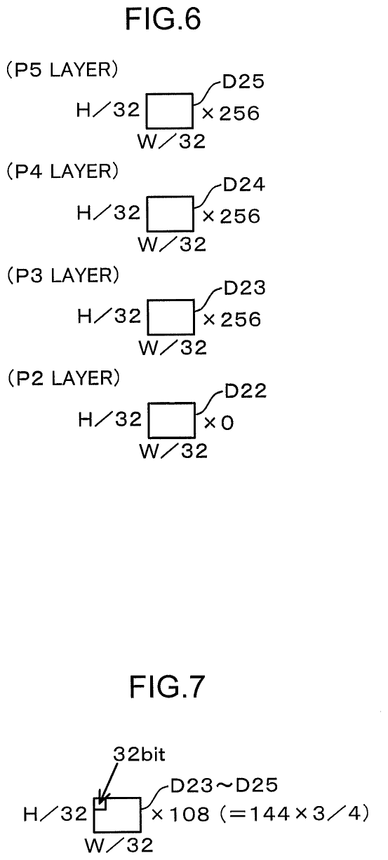

FIG. 6 is a view illustrating the intermediate feature maps D22 to D25 input to the convolution processing units 62 to 65 after the size conversion processing regarding the example illustrated in FIG. 2A. By reducing the size of the feature map D12 to 1/8 regarding each of the horizontal and vertical directions, the downsampling unit 52D generates the intermediate feature map D22 of which the horizontal size is W/32 and the vertical size is H/32. However, in the example illustrated in FIG. 2A, since the second method is selected for the P2 layer, the downsampling unit 52D does not generate the intermediate feature map D22, and the intermediate feature map D22 is not input to the convolution processing unit 62. By reducing the size of the feature map D13 to 1/4 regarding each of the horizontal and vertical directions, the downsampling unit 53D inputs 256 intermediate feature maps D23 of which the horizontal size is W/32 and the vertical size is H/32 to the convolution processing unit 63. By reducing the size of the feature map D14 to 1/2 regarding each of the horizontal and vertical directions, the downsampling unit 54D inputs 256 intermediate feature maps D24 of which the horizontal size is W/32 and the vertical size is H/32 to the convolution processing unit 64. Note that for the P5 layer, 256 intermediate feature maps D25 identical to the feature map D15 are input to the convolution processing unit 65.

FIG. 7 is a view illustrating the intermediate feature maps D23 to D25 input to the image generation unit 72 after the convolution processing regarding the example illustrated in FIG. 2A. If the first method is selected for all the hierarchical layers of the P2 layer to the P5 layer, the convolution processing units 62 to 65 reduce the total number of the intermediate feature maps D22 to D25 from 1024 (=256×4) to, for example, 144 by the convolution processing. In the example illustrated in FIG. 2A, since the second method is selected for the P2 layer, and the 256 intermediate feature maps D22 are not input to the convolution processing unit 62, the convolution processing units 63 to 65 reduce the total number of the intermediate feature maps D23 to D25 from 768 (=256×3) to 108 (=144×3/4) by the convolution processing. As illustrated in FIGS. 2A and 2B, in the example of the present embodiment, any of the first method and the second method can be selected for each hierarchical layer of the P2 layer to the P5 layer, and the total number of the intermediate feature maps D22 to D25 input from the convolution processing units 62 to 65 to the image generation unit 72 decreases as the number of hierarchical layers in which the second method is selected among the plurality of hierarchical layers increases, and increases as the number of hierarchical layers in which the first method is selected increases. Note that the number of bits of each pixel of the intermediate feature maps D23 to D25 is 32 bits in the example of the present embodiment.

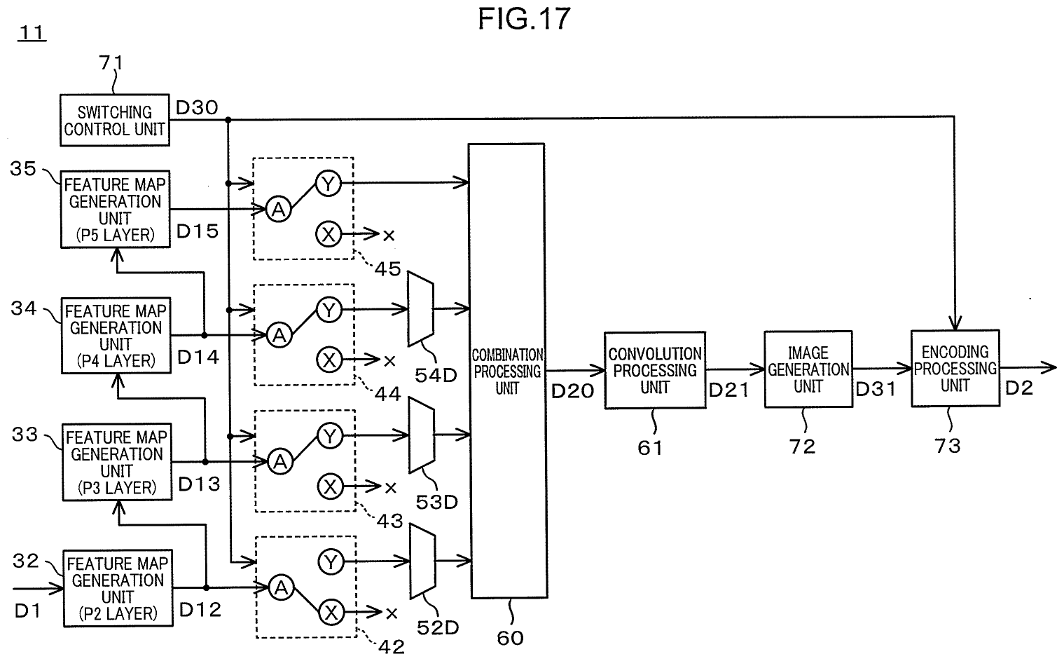

FIG. 17 is a view illustrating the configuration of the information processing unit 11 according to a modification. In the configuration of the embodiment, the intermediate feature maps D22 to D25 of which the total number of maps has been reduced are generated by performing the convolution processing on each signal selected from the feature maps D12 to D15 and subjected to downsampling or upsampling for the each of the hierarchical layers of the P2 layer to the P5 layer. In place of the configuration of the embodiment, as illustrated in FIG. 17, the intermediate feature map D21 of which the total number of maps has been reduced may be configured to be generated by combining the signals selected from the feature maps D12 to D15 and subjected to downsampling or upsampling for the each of the hierarchical layers of the P2 layer to the P5 layer by a combination processing unit 60, and performing convolution processing by a convolution processing unit 61 on the signal D20 that is combined. According to the configuration according to the modification, the convolution processing units 62 to 65 are consolidated into one convolution processing unit 61, and the convolution processing can be collectively performed while using the signals of all the hierarchical layers, and thus there is a possibility that a more optimal feature map can be generated.

With reference to FIG. 3, next in step SP13, the image generation unit 72 generates an image D31 based on the intermediate feature maps D22 to D25 input from the convolution processing units 62 to 65.

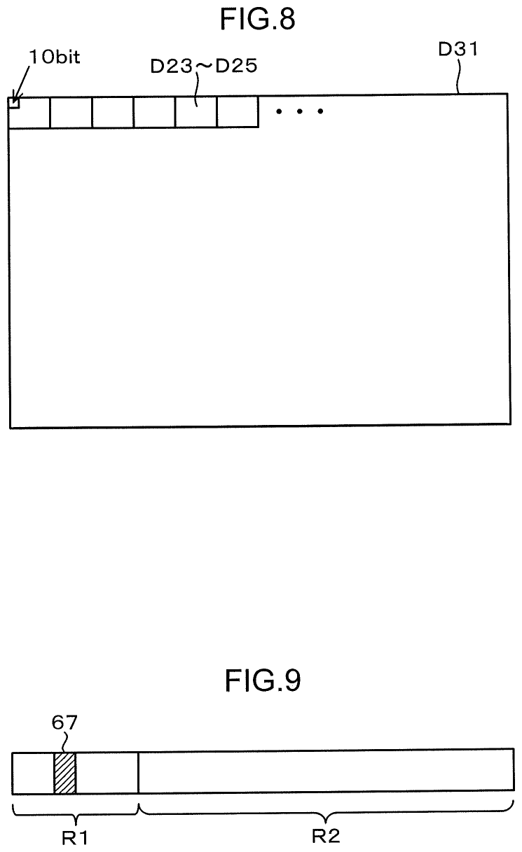

FIG. 8 is a view illustrating generation processing of the image D31 by the image generation unit 72 regarding the example illustrated in FIG. 2A. The image generation unit 72 generates the image D31 by performing packing processing of arraying, in a frame in raster scan order sequentially from the upper hierarchical layer, the intermediate feature maps D23 to D25 input from the convolution processing units 63 to 65. At that time, the image generation unit 72 reduces the number of bits of each pixel of the intermediate feature maps D23 to D25 from 32 bits to 10 bits by quantization processing of truncating lower bits. Note that the array order of the intermediate feature maps D23 to D25 may be arrayed sequentially from the lower hierarchical layer, or may be an order different from the raster scan order.

Next in step SP14, the encoding processing unit 73 generates the bitstream D2 by encoding the image D31 input from the image generation unit 72 by a predetermined compression encoding system such as versatile video encoding (VVC). The encoding processing unit 73 transmits the bitstream D2 that is generated to the decoder 2 via the transmission channel NW.

FIG. 9 is a view illustrating an example of the data structure of the bitstream D2. The bitstream D2 includes a header region R1 in which management information and the like are stored and a payload region R2 in which image data is stored. The encoding processing unit 73 stores, into the payload region R2, encoded data in which the image D31 is encoded. The parameter D30 is input from the switching control unit 71 to the encoding processing unit 73, and the encoding processing unit 73 stores, in a predetermined location of the header region R1, encoded data 67 in which the parameter D30 is encoded. The predetermined location is, for example, a supplemental enhancement information (SEI) region for storing additional information. The predetermined location may be VPS, SPS, PPS, PH, SH, APS, or a tile header. By storing the encoded data 67 of the parameter D30 into the header region R1 of the bitstream D2, the decoder 2 can easily obtain the parameter D30 by decoding. By storing the encoded data 67 into the SEI region, the parameter D30 can be easily handled as additional information. Note that the encoding processing unit 73 may store the encoded data 67 of the parameter D30 into the payload region R2.

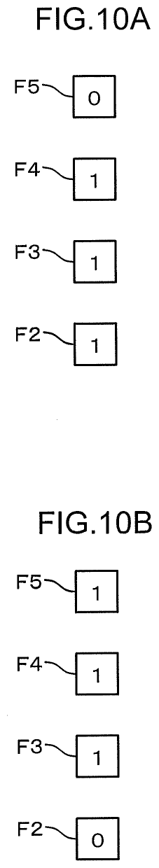

FIGS. 10A and 10B are views illustrating the first example of the data structure of the parameter D30. The parameter D30 includes four flags F2 to F5 corresponding to the four hierarchical layers of the P2 layer to the P5 layer. The value of each of the flags F2 to F5 indicates which of the first method and the second method to have been selected for the corresponding hierarchical layer. If the value of each flag is “1”, it indicates that the first method is selected for the corresponding hierarchical layer, and if the value of each flag is “0”, it indicates that the second method is selected for the corresponding hierarchical layer. FIG. 10A corresponds to FIG. 2B, and illustrates that the first method is selected for the P2 layer to the P4 layer, and the second method is selected for the P5 layer. FIG. 10B corresponds to FIG. 2A, and illustrates that the first method is selected for the P3 layer to the P5 layer, and the second method is selected for the P2 layer.

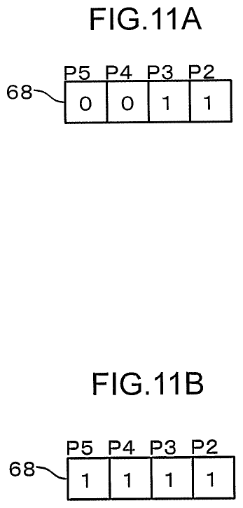

FIGS. 11A and 11B are views illustrating the second example of the data structure of the parameter D30. The parameter D30 includes data 68 of 4 bits corresponding to the four hierarchical layers of the P2 layer to the P5 layer. The value of each bit of the data 68 indicates which of the first method and the second method to have been selected for the corresponding hierarchical layer. If the value of each bit is “1”, it indicates that the first method is selected for the corresponding hierarchical layer, and if the value of each bit is “0”, it indicates that the second method is selected for the corresponding hierarchical layer. FIG. 11A illustrates that the first method is selected for the P2 layer and the P3 layer, and the second method is selected for the P4 layer and the P5 layer. FIG. 11B illustrates that the first method is selected for all the hierarchical layers of the P2 layer to the P5 layer.

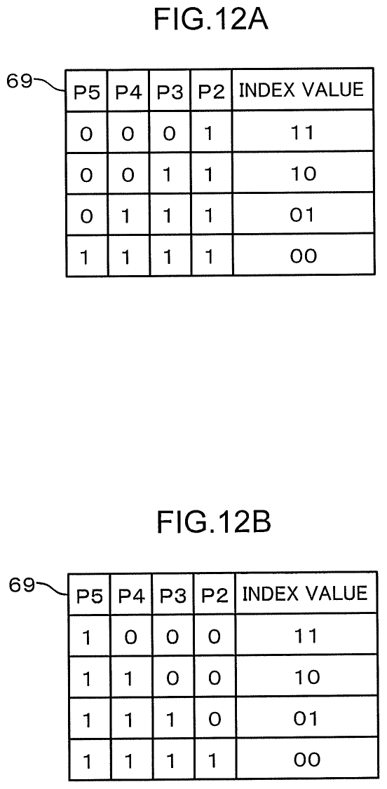

FIGS. 12A and 12B are views illustrating the third example of the data structure of the parameter D30. Regarding a combination of which of the first method and the second method to select for each hierarchical layer of the P2 layer to the P5 layer, a plurality of patterns are defined in advance in table information 69, and an index value is given as information for specifying each pattern. In this example, four patterns are defined, and 2-bit index values are given. The switching control unit 71 selects one pattern from the four patterns and includes, into the parameter D30, an index value corresponding to the selected pattern. In the example illustrated in FIG. 12A, if a pattern having an index value of “11” is selected, the first method is selected for the P2 layer, and the second method is selected for the P3 layer to the P5 layer. If a pattern having an index value of “10” is selected, the first method is selected for the P2 layer and the P3 layer, and the second method is selected for the P4 layer and the P5 layer. If a pattern having an index value of “01” is selected, the first method is selected for the P2 layer to the P4 layer, and the second method is selected for the P5 layer. If a pattern having an index value of “00” is selected, the first method is selected for all the hierarchical layers of the P2 layer to the P5 layer. In the example illustrated in FIG. 12B, if a pattern having an index value of “11” is selected, the first method is selected for the P5 layer, and the second method is selected for the P2 layer to the P4 layer. If a pattern having an index value of “10” is selected, the first method is selected for the P4 layer and the P5 layer, and the second method is selected for the P2 layer and the P3 layer. If a pattern having an index value of “01” is selected, the first method is selected for the P3 layer to the P5 layer, and the second method is selected for the P2 layer. If a pattern having an index value of “00” is selected, the first method is selected for all the hierarchical layers of the P2 layer to the P5 layer.

### (Configuration and Processing of Decoding Device 2)

FIG. 13A is a view illustrating the first configuration example of the information processing unit 21. FIG. 13A illustrates, corresponding to FIG. 2A, an example of a case where the sizes of a plurality of intermediate feature maps D42 having uniform sizes are equal to the size of a feature map D15A having the smallest size among a plurality of feature maps D12A to D15A generated in the plurality of hierarchical layers of the P2 layer to the P5 layer.

The information processing unit 21 includes the neural network 25 including the four hierarchical layers of the P2 layer to the P5 layer. However, the number of hierarchical layers included in the neural network 25 is not limited to 4, and may be 2 or more. Specifically, the information processing unit 21 includes a switching control unit 81, a decoding processing unit 82, an intermediate feature map generation unit 83, convolution processing units 92 to 95, upsampling units 102U to 104U and 113U to 115U, adders 122U to 124U, and switching processing units 132 to 134. Note that examples of the mathematical operation are not limited to addition by the adders 122U to 124U, and may be subtraction, shift, convolution, or any combination thereof.

The convolution processing unit 92, the upsampling unit 102U, the adder 122U, and the switching processing unit 132 correspond to the P2 layer, which is the lowest layer. The convolution processing unit 93, the upsampling unit 103U, the adder 123U, and the switching processing unit 133 correspond to the P3 layer, which is higher by one hierarchical layer than the P2 layer. The convolution processing unit 94, the upsampling unit 104U, the adder 124U, and the switching processing unit 134 correspond to the P4 layer, which is higher by one hierarchical layer than the P3 layer. The convolution processing unit 95 corresponds to the P5 layer, which is the highest layer.

The switching processing units 132 to 134 include the terminal X and the terminal Y on the input side and a terminal B on the output side, and select and connect one of the terminal X and the terminal Y to the terminal B based on the parameter D30 input from the switching control unit 81. In the example illustrated in FIG. 13A, corresponding to FIG. 2A, the switching processing unit 132 connects the terminal X to the terminal B, and the switching processing units 133 and 134 connect the terminal Y to the terminal B. The switching control unit 81 inputs, to the switching processing units 132 to 134, the parameter D30 decoded from the bitstream D2 by the decoding processing unit 82.

The switching control unit 81 controls the switching processing units 132 to 134 based on the parameter D30 decoded from the bitstream D2 by the decoding processing unit 82. Based on the parameter D30, for example, when the size of the object of a detection target in the machine task executed by the machine task processing unit 3 is equal to or greater than a predetermined threshold, or when global information is required in the machine task executed by the machine task processing unit 3, the switching control unit 81 connects the terminal X to the terminal B for at least the P2 layer having the largest size of the generated feature map among the P2 layer to the P5 layer. In this case, at least the feature map D12A of the P2 layer is generated not using an intermediate feature map D432 of the P2 layer but using the feature map D13A generated in the P3 layer higher by one hierarchical layer. Note that the switching control unit 81 may connect the terminal X to the terminal B not only for one hierarchical layer of the P2 layer but also for the two hierarchical layers of the P2 layer and the P3 layer or the three hierarchical layers of the P2 layer to the P4 layer.

FIG. 13B is a view illustrating the second configuration example of the information processing unit 21. FIG. 13B illustrates, corresponding to FIG. 2B, an example of a case where the sizes of the plurality of intermediate feature maps D42 having uniform sizes are equal to the size of the feature map D12A having the largest size among the plurality of feature maps D12A to D15A generated in the plurality of hierarchical layers of the P2 layer to the P5 layer.

The information processing unit 21 includes the neural network 25 including the hierarchical layers of the four hierarchical layers of the P2 layer to the P5 layer. However, the number of hierarchical layers included in the neural network 25 is not limited to 4, and may be 2 or more. Specifically, the information processing unit 21 includes the switching control unit 81, the decoding processing unit 82, the intermediate feature map generation unit 83, the convolution processing units 92 to 95, downsampling units 103D to 105D and 112D to 114D, adders 123D to 125D, and switching processing units 143 to 145.

The convolution processing unit 92 corresponds to the P2 layer, which is the lowest layer. The convolution processing unit 93, the downsampling unit 103D, the adder 123D, and the switching processing unit 143 correspond to the P3 layer, which is higher by one hierarchical layer than the P2 layer. The convolution processing unit 94, the downsampling unit 104D, the adder 124D, and the switching processing unit 144 correspond to the P4 layer, which is higher by one hierarchical layer than the P3 layer. The convolution processing unit 95, the downsampling unit 105D, the adder 125D, and the switching processing unit 145 correspond to the P5 layer, which is the highest layer.

The switching processing units 143 to 145 include the terminal X and the terminal Y on the input side and the terminal B on the output side, and select and connect one of the terminal X and the terminal Y to the terminal B based on the parameter D30 input from the switching control unit 81. In the example illustrated in FIG. 13B, corresponding to FIG. 2B, the switching processing units 143 and 144 connect the terminal Y to the terminal B, and the switching processing unit 145 connects the terminal X to the terminal B. The switching control unit 81 inputs, to the switching processing units 143 to 145, the parameter D30 decoded from the bitstream D2 by the decoding processing unit 82.

The switching control unit 81 controls the switching processing units 132 to 134 based on the parameter D30 decoded from the bitstream D2 by the decoding processing unit 82. Based on the parameter D30, for example, when the size of the object of a detection target in the machine task executed by the machine task processing unit 3 is less than the predetermined threshold, or when local information is required in the machine task executed by the machine task processing unit 3, the switching control unit 81 connects the terminal X to the terminal B for at least the P5 layer having the smallest size of the generated feature map among the P2 layer to the P5 layer. In this case, at least the feature map D15A of the P5 layer is generated not using an intermediate feature map D435 of the P5 layer but using the feature map D14A generated in the P4 layer lower by one hierarchical layer. Note that the switching control unit 81 may connect the terminal X to the terminal B not only for one hierarchical layer of the P5 layer but also for the two hierarchical layers of the P4 layer and the P5 layer or the three hierarchical layers of the P3 layer to the P5 layer.

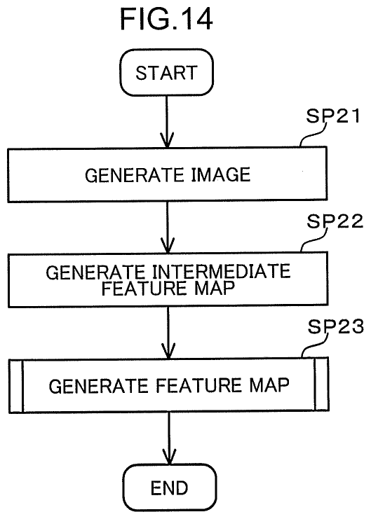

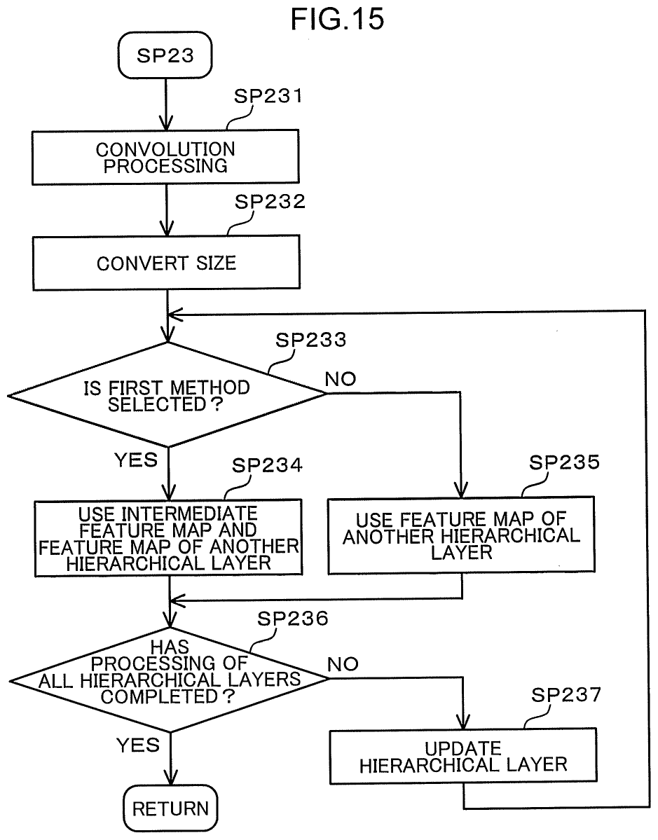

FIG. 14 is a flowchart showing the flow of the processing executed by the information processing unit 21. FIG. 15 is a flowchart showing details of generation processing (step SP23) of a feature map executed as a subroutine.

First in step SP21, the decoding processing unit 82 generates an image D41 corresponding to the image D31 by decoding the bitstream D2 received from the encoder 1. The decoding processing unit 82 obtains the parameter D30 by decoding the encoded data 67 stored in, for example, the SEI region of the bitstream D2, and inputs, to the switching control unit 81, the parameter D30 that is obtained.

Next in step SP22, the intermediate feature map generation unit 83 generates the intermediate feature maps D42 corresponding to the intermediate feature maps D22 to D25 based on the image D41 input from the decoding processing unit 82.

Specifically, the intermediate feature map generation unit 83 generates the intermediate feature maps D42 by performing unpacking processing of developing, in raster scan order sequentially from the upper hierarchical layer, the intermediate feature maps D22 to D25 included in the image D41 input from the decoding processing unit 82. At that time, the intermediate feature map generation unit 83 increases the number of bits of each pixel of the intermediate feature maps D42 from 10 bits to 32 bits by inverse quantization processing. Note that the development order of the intermediate feature maps D22 to D25 may be developed sequentially from the lower hierarchical layer, or may be an order different from the raster scan order. The intermediate feature map generation unit 83 inputs, to the convolution processing units 92 to 95, the intermediate feature maps D42 that is generated. Note that the total number of intermediate feature maps D42 decreases as the number of hierarchical layers in which the second method is selected among the plurality of hierarchical layers in the encoder 1 increases, and increases as the number of hierarchical layers in which the first method is selected increases.

Next in step SP23, the feature maps D12A to D15A corresponding to the feature maps D12 to D15 are generated using the processing flow shown in FIG. 15 based on the intermediate feature maps D42 and the parameter D30.

Specifically, first in step SP231, convolution processing for returning the number of intermediate feature maps D42 to the number of feature maps D12 to D15 is performed. The convolution processing units 92 to 95 generate, for example, 256 intermediate feature maps D432 to D435 for each hierarchical layer of the P2 layer to the P5 layer from, for example, 108 intermediate feature maps D42 by convolution processing using, for example, 256 filters. In the example illustrated in FIG. 13A, 256 feature maps D15A of the P5 layer are obtained as the intermediate feature map D435 output from the convolution processing unit 95. In the example illustrated in FIG. 13B, 256 feature maps D12A of the P2 layer are obtained as the intermediate feature map D432 output from the convolution processing unit 92.

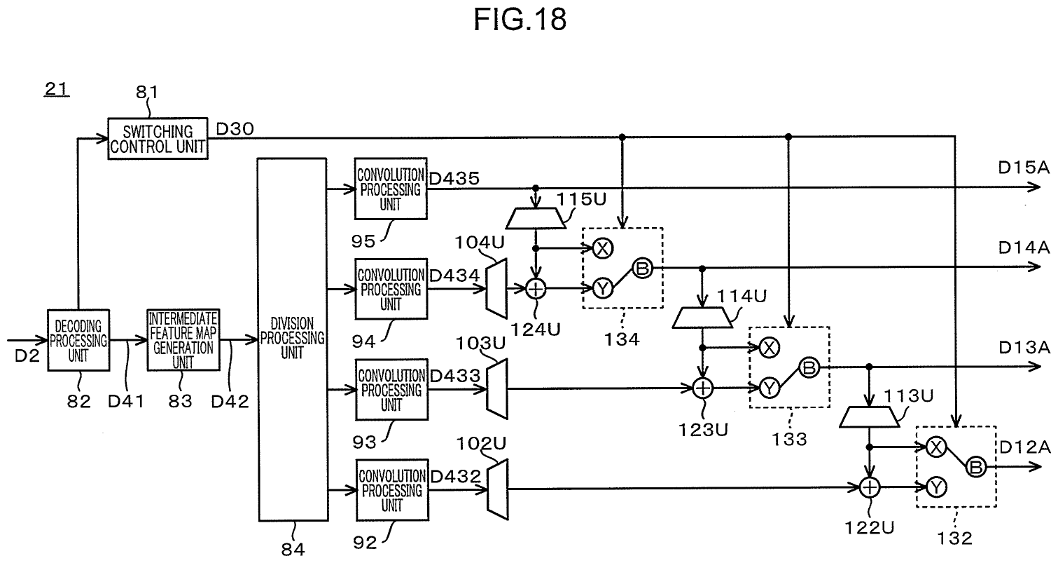

FIG. 18 is a view illustrating the configuration of the information processing unit 21 according to a modification. In the configuration of the embodiment, the convolution processing units 92 to 94 perform the convolution processing on the intermediate feature maps D42 of which the total number of maps has been reduced, thereby generating the intermediate feature maps D432 to D435 of which the number of maps has been returned for each hierarchical layer of the P2 layer to the P5 layer. In place of the configuration of the embodiment, as illustrated in FIG. 18, the intermediate feature maps D432 to D435 of which the number of maps has been returned may be configured to be generated by a division processing unit 84 dividing, for each hierarchical layer of the P2 layer to the P5 layer, the intermediate feature maps D42 of which the total number of maps has been reduced, and the convolution processing units 92 to 95 performing convolution processing on each of the intermediate feature maps D42 that are divided. At this time, based on the parameter D30, for example, if it is known that the intermediate feature map D432 is not used by the switching processing unit 132, the division processing unit 84 may divide the intermediate feature maps D42 for each hierarchical layer of the P3 layer to the P5 layer. According to the configuration according to the modification, there is a possibility that the processing amount required in each of the convolution processing units 92 to 95 can be reduced.

Next in step SP232, size conversion processing for returning the sizes of the intermediate feature maps D432 to D435 to the sizes of the feature maps D12 to D15 is performed. Note that the size conversion processing in step SP232 is omitted for the P5 layer in FIG. 13A not provided with the upsampling units 102U to 104U and the P2 layer in FIG. 13B not provided with the downsampling units 103D to 105D. The upsampling unit 102U enlarges the size of the intermediate feature map D432 by 8 times regarding each of the horizontal and vertical directions, the upsampling unit 103U enlarges the size of the intermediate feature map D433 by 4 times regarding each of the horizontal and vertical directions, and the upsampling unit 104U enlarges the size of the intermediate feature map D434 by 2 times regarding each of the horizontal and vertical directions. The downsampling unit 103D reduces the size of the intermediate feature map D433 by 1/2 times regarding each of the horizontal and vertical directions, the downsampling unit 104D reduces the size of the intermediate feature map D434 by 1/4 times regarding each of the horizontal and vertical directions, and the downsampling unit 105D reduces the size of the intermediate feature map D435 by 1/8 times regarding each of the horizontal and vertical directions.

As described above, in the example illustrated in FIG. 13A, the 256 feature maps D15A of the P5 layer are obtained as the intermediate feature map D435 output from the convolution processing unit 95. The feature map D15A has a horizontal size of W/32 and a vertical size of H/32.

Next in step SP233, the switching processing unit 134 determines whether the first method is selected or the second method is selected for the P4 layer based on the parameter D30. The first method is a method of using the intermediate feature map D434 in generation of the feature map D14A, and the second method is a method of not using the intermediate feature map D434 in generation of the feature map D14A.

If the first method is selected for the P4 layer (step SP233: YES), next in step SP234, the switching processing unit 134 generates the feature map D14A of the P4 layer by using the intermediate feature map D434 of the P4 layer and the feature map D15A of the P5 layer higher by one hierarchical layer by connecting the terminal Y to the terminal B. The upsampling unit 115U enlarges the size of the feature map D15A by 2 times regarding each of the horizontal and vertical directions. The adder 124U generates the feature map D14A by adding the intermediate feature map D434 output from the upsampling unit 104U and the feature map D15A output from the upsampling unit 115U. The feature map D14A has a horizontal size of W/16 and a vertical size of H/16.

If the second method is selected for the P4 layer (step SP233: NO), next in step SP235, the switching processing unit 134 generates the feature map D14A of the P4 layer by not using an intermediate feature map D434 of the P4 layer but using the feature map D15A of the P5 layer higher by one hierarchical layer by connecting the terminal X to the terminal B. The feature map D14A is obtained as the feature map D15A output from the upsampling unit 115U.

Next in step SP236, it is determined whether or not the generation processing of the feature map has been completed for all the hierarchical layers of the P2 layer to the P5 layer.

If there is an unprocessed hierarchical layer (step SP236: NO), the hierarchical layer is updated from the P4 layer to the P3 layer in step SP237, and then in step SP233, the switching processing unit 133 determines whether the first method is selected or the second method is selected for the P3 layer based on the parameter D30. The first method is a method of using the intermediate feature map D433 in generation of the feature map D13A, and the second method is a method of not using the intermediate feature map D433 in generation of the feature map D13A.

If the first method is selected for the P3 layer (step SP233: YES), next in step SP234, the switching processing unit 133 generates the feature map D13A of the P3 layer by using the intermediate feature map D433 of the P3 layer and the feature map D14A of the P4 layer higher by one hierarchical layer by connecting the terminal Y to the terminal B. The upsampling unit 114U enlarges the size of the feature map D14A by 2 times regarding each of the horizontal and vertical directions. The adder 123U generates the feature map D13A by adding the intermediate feature map D433 output from the upsampling unit 103U and the feature map D14A output from the upsampling unit 114U. The feature map D13A has a horizontal size of W/8 and a vertical size of H/8.

If the second method is selected for the P3 layer (step SP233: NO), next in step SP235, the switching processing unit 133 generates the feature map D13A of the P3 layer by not using an intermediate feature map D433 of the P3 layer but using the feature map D14A of the P4 layer higher by one hierarchical layer by connecting the terminal X to the terminal B. The feature map D13A is obtained as the feature map D14A output from the upsampling unit 114U.

Next in step SP236, it is determined whether or not the generation processing of the feature map has been completed for all the hierarchical layers of the P2 layer to the P5 layer.

If there is an unprocessed hierarchical layer (step SP236: NO), the hierarchical layer is updated from the P3 layer to the P2 layer in step SP237, and then in step SP233, the switching processing unit 132 determines whether the first method is selected or the second method is selected for the P2 layer based on the parameter D30. The first method is a method of using the intermediate feature map D432 in generation of the feature map D12A, and the second method is a method of not using the intermediate feature map D432 in generation of the feature map D12A.

If the first method is selected for the P2 layer (step SP233: YES), next in step SP234, the switching processing unit 132 generates the feature map D12A of the P2 layer by using the intermediate feature map D432 of the P2 layer and the feature map D13A of the P3 layer higher by one hierarchical layer by connecting the terminal Y to the terminal B. The upsampling unit 113U enlarges the size of the feature map D13A by 2 times regarding each of the horizontal and vertical directions. The adder 122U generates the feature map D12A by adding the intermediate feature map D432 output from the upsampling unit 102U and the feature map D13A output from the upsampling unit 113U. The feature map D12A has a horizontal size of W/4 and a vertical size of H/4.

If the second method is selected for the P2 layer (step SP233: NO), next in step SP235, the switching processing unit 132 generates the feature map D12A of the P2 layer by not using an intermediate feature map D432 of the P2 layer but using the feature map D13A of the P3 layer higher by one hierarchical layer by connecting the terminal X to the terminal B. The feature map D12A is obtained as the feature map D13A output from the upsampling unit 113U.

If there is no unprocessed hierarchical layer (step SP236: YES), the generation processing of the feature map is ended.

As described above, in the example illustrated in FIG. 13B, the 256 feature maps D12A of the P2 layer are obtained as the intermediate feature map D432 output from the convolution processing unit 92. The feature map D12A has the horizontal size of W/4 and the vertical size of H/4.

In step SP233, the switching processing unit 143 determines whether the first method is selected or the second method is selected for the P3 layer based on the parameter D30.

If the first method is selected for the P3 layer (step SP233: YES), next in step SP234, the switching processing unit 143 generates the feature map D13A of the P3 layer by using the intermediate feature map D433 of the P3 layer and the feature map D12A of the P2 layer lower by one hierarchical layer by connecting the terminal Y to the terminal B. The downsampling unit 112D reduces the size of the feature map D12A by 1/2 times regarding each of the horizontal and vertical directions. The adder 123D generates the feature map D13A by adding the intermediate feature map D433 output from the downsampling unit 103D and the feature map D12A output from the downsampling unit 112D.

If the second method is selected for the P3 layer (step SP233: NO), next in step SP235, the switching processing unit 143 generates the feature map D13A of the P3 layer by not using the intermediate feature map D433 of the P3 layer but using the feature map D12A of the P2 layer lower by one hierarchical layer by connecting the terminal X to the terminal B. The feature map D13A is obtained as the feature map D12A output from the downsampling unit 112D.

Next in step SP236, it is determined whether or not the generation processing of the feature map has been completed for all the hierarchical layers of the P2 layer to the P5 layer.

If there is an unprocessed hierarchical layer (step SP236: NO), the hierarchical layer is updated from the P3 layer to the P4 layer in step SP237, and then in step SP233, the switching processing unit 144 determines whether the first method is selected or the second method is selected for the P4 layer based on the parameter D30.

If the first method is selected for the P4 layer (step SP233: YES), next in step SP234, the switching processing unit 144 generates the feature map D14A of the P4 layer by using the intermediate feature map D434 of the P4 layer and the feature map D13A of the P3 layer lower by one hierarchical layer by connecting the terminal Y to the terminal B. The downsampling unit 113D reduces the size of the feature map D13A by 1/2 times regarding each of the horizontal and vertical directions. The adder 124D generates the feature map D14A by adding the intermediate feature map D434 output from the downsampling unit 104D and the feature map D13A output from the downsampling unit 113D.

If the second method is selected for the P4 layer (step SP233: NO), next in step SP235, the switching processing unit 144 generates the feature map D14A of the P4 layer by not using the intermediate feature map D434 of the P4 layer but using the feature map D13A of the P3 layer lower by one hierarchical layer by connecting the terminal X to the terminal B. The feature map D14A is obtained as the feature map D13A output from the downsampling unit 113D.

Next in step SP236, it is determined whether or not the generation processing of the feature map has been completed for all the hierarchical layers of the P2 layer to the P5 layer.

If there is an unprocessed hierarchical layer (step SP236: NO), the hierarchical layer is updated from the P4 layer to the P5 layer in step SP237, and then in step SP233, the switching processing unit 145 determines whether the first method is selected or the second method is selected for the P5 layer based on the parameter D30.

If the first method is selected for the P5 layer (step SP233: YES), next in step SP234, the switching processing unit 145 generates the feature map D15A of the P5 layer by using the intermediate feature map D435 of the P5 layer and the feature map D14A of the P4 layer lower by one hierarchical layer by connecting the terminal Y to the terminal B. The downsampling unit 114D reduces the size of the feature map D14A by 1/2 times regarding each of the horizontal and vertical directions. The adder 125D generates the feature map D15A by adding the intermediate feature map D435 output from the downsampling unit 105D and the feature map D14A output from the downsampling unit 114D.

If the second method is selected for the P5 layer (step SP233: NO), next in step SP235, the switching processing unit 145 generates the feature map D15A of the P5 layer by not using the intermediate feature map D435 of the P5 layer but using the feature map D14A of the P4 layer lower by one hierarchical layer by connecting the terminal X to the terminal B. The feature map D15A is obtained as the feature map D14A output from the downsampling unit 114D.

If there is no unprocessed hierarchical layer (step SP236: YES), the generation processing of the feature map is ended.

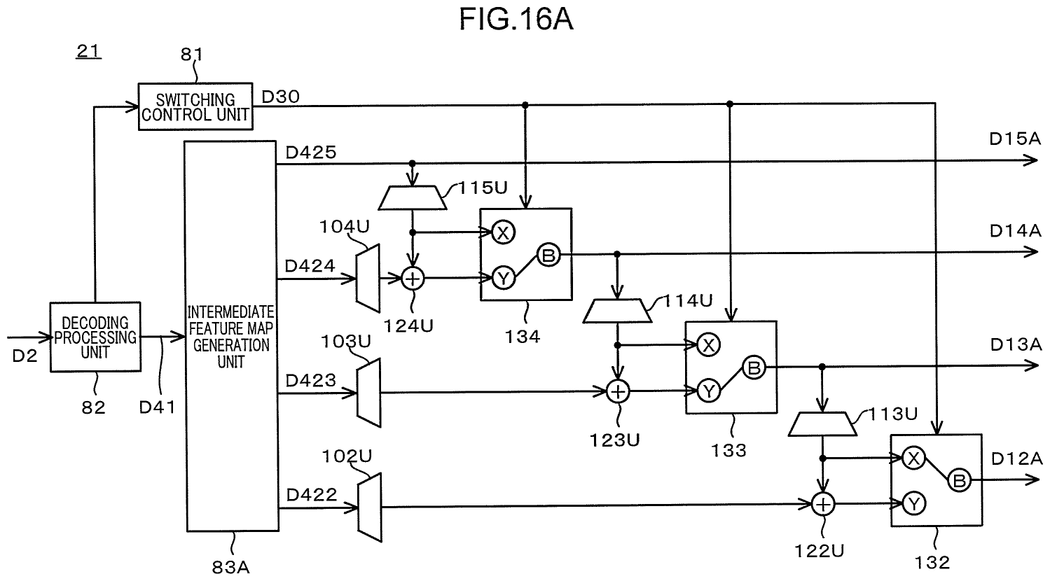

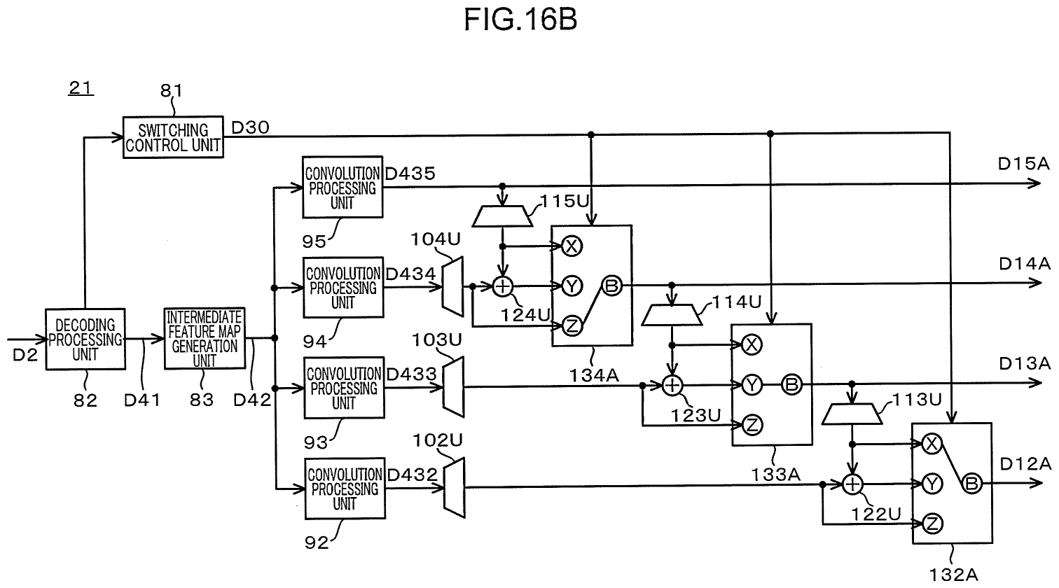

FIG. 16A is a view illustrating the third configuration example of the information processing unit 21. The convolution processing units 92 to 95 are omitted from the first configuration example illustrated in FIG. 13A. In this case, the convolution processing units 62 to 65 illustrated in FIG. 2A are also omitted, and 256 intermediate feature maps D23 to D25 of which the horizontal size is W/32 and the vertical size is H/32 are encoded for each hierarchical layer of the P3 layer to the P5 layer in which the first method is selected, and are transmitted to the decoder 2 as the bitstream D2. Therefore, in the example illustrated in FIGS. 2A and 16A, the bitstream D2 including a total of 768 (=256×3) intermediate feature maps D23 to D25 of the P3 layer to the P5 layer is transmitted. The intermediate feature map generation unit 83A extracts and outputs, to the P3 layer, 256 intermediate feature maps D423 corresponding to the P3 layer from among the total of 768 intermediate feature maps D423 to D425 corresponding to the intermediate feature maps D23 to D25. As a result, regarding the P3 layer, 256 feature maps D13A smaller in number than the total of 768 intermediate feature maps D423 to D425 are generated using the intermediate feature map D423. The intermediate feature map generation unit 83A extracts and outputs, to the P4 layer, 256 intermediate feature maps D424 corresponding to the P4 layer from among the total of 768 intermediate feature maps D423 to D425. As a result, regarding the P4 layer, 256 feature maps D14A smaller in number than the total of 768 intermediate feature maps D423 to D425 are generated using the intermediate feature map D424. The intermediate feature map generation unit 83A extracts and outputs, to the P5 layer, 256 intermediate feature maps D425 corresponding to the P5 layer from among the total of 768 intermediate feature maps D423 to D425. As a result, regarding the P5 layer, 256 feature maps D15A smaller in number than the total of 768 intermediate feature maps D423 to D425 are generated using the intermediate feature map D425. Note that since the second method is selected regarding the P2 layer, 256 feature maps D12A are generated not using the intermediate feature map D422 of the P2 layer but using the feature map D13A of the P3 layer. The third configuration example illustrated in FIG. 16A can be applied not only to the first configuration example illustrated in FIG. 13A but also to the second configuration example illustrated in FIG. 13B.

FIG. 16B is a view illustrating the fourth configuration example of the information processing unit 21. In place of the switching processing units 132 to 134 illustrated in FIG. 13A, switching processing units 132A to 134A further including a terminal Z on an input side are mounted. When the terminal Z is selected and connected to the terminal B, the adders 122U to 124U are bypassed, whereby the intermediate feature maps D432 to D434 output from the upsampling units 102U to 104U are obtained as the feature maps D12A to D14A. The fourth configuration example illustrated in FIG. 16B can be applied not only to the first configuration example illustrated in FIG. 13A but also to the second configuration example illustrated in FIG. 13B.

### Effects

According to the encoder 1 according to the present embodiment, for at least one hierarchical layer of the plurality of hierarchical layers included in the neural network 15, any of the first method of generating the plurality of intermediate feature maps using the plurality of feature maps generated in the hierarchical layer and the second method of generating the plurality of intermediate feature maps not using the plurality of feature maps generated in the hierarchical layer is selected. By making any of the first method and the second method selectable, it is possible to apply the optimum encoding processing in accordance with the image, the content of the machine task, or the like. When the second method is selected for the hierarchical layer, since it is possible to omit encoding of the plurality of intermediate feature maps for the hierarchical layer, it is possible to reduce the data amount of the bitstream D2 transmitted from the encoder 1 to the decoder 2.

According to the decoder 2 according to the present embodiment, for at least one hierarchical layer of the plurality of hierarchical layers included in the neural network 25, the first method is selected in the decoder 2 when the encoding of the feature map is not omitted in the encoder 1 and the second method is selected in the decoder 2 when the encoding of the feature map is omitted in the encoder 1. This can appropriately reconstruct the feature map of the hierarchical layer in the decoder 2 even if the encoding of an intermediate feature map of some hierarchical layers is omitted in the encoder 1. As a result, it is possible to prevent the inference accuracy of the machine task from decreasing.

The present disclosure is particularly useful for application to object detection systems using neural networks for machine tasks.

1. A decoder comprising:
circuitry; and
a memory connected to the circuitry,
wherein the circuitry, in operation,
generates an image by decoding a bitstream,
generates a plurality of intermediate feature maps having a uniform size based on the image,
generates, based on the plurality of intermediate feature maps, a plurality of feature maps having different sizes for each hierarchical layer in a plurality of hierarchical layers included in a neural network for a machine task, and
in generation of the feature maps, for at least one hierarchical layer of the plurality of hierarchical layers, selects any of:
a first method of generating the plurality of feature maps of the at least one hierarchical layer using the plurality of intermediate feature maps, and
a second method of generating the plurality of feature maps of the at least one hierarchical layer without using the plurality of intermediate feature maps but using the plurality of feature maps generated in a hierarchical layer different from the at least one hierarchical layer of the plurality of hierarchical layers.

2. The decoder according to claim 1, wherein the circuitry, in operation,
obtains, from the bitstream, a parameter indicating which of the first method and the second method is selected for the at least one hierarchical layer, and
in generation of the feature map, selects, based on the parameter, any of the first method and the second method for the at least one hierarchical layer.

3. The decoder according to claim 2, wherein the circuitry, in operation,
selects any of the first method and the second method for each hierarchical layer of the plurality of hierarchical layers,
the parameter includes a plurality of flags corresponding to the plurality of hierarchical layers, and
a value of each flag of the plurality of flags indicates which of the first method and the second method to select for a corresponding hierarchical layer.

4. The decoder according to claim 2, wherein the circuitry, in operation,
selects any of the first method and the second method for each hierarchical layer of the plurality of hierarchical layers,
the parameter includes data of a plurality of bits corresponding to the plurality of hierarchical layers, and
a value of each bit of the plurality of bits indicates which of the first method and the second method to select for a corresponding hierarchical layer.

5. The decoder according to claim 2, wherein the circuitry, in operation,
selects any of the first method and the second method for each hierarchical layer of the plurality of hierarchical layers,
a plurality of patterns are defined in advance regarding a combination of which of the first method and the second method to select for each hierarchical layer of the plurality of hierarchical layers,
one pattern is selected from among the plurality of patterns, and
the parameter includes information specifying the one pattern.

6. The decoder according to claim 2, wherein the circuitry, in operation, obtains the parameter by decoding a supplemental enhancement information (SEI) region of the bitstream.

7. The decoder according to claim 1, wherein when the first method is selected for the at least one hierarchical layer, the circuitry, in operation,
generates the plurality of feature maps of the hierarchical layer using the plurality of intermediate feature maps and the plurality of feature maps generated in a hierarchical layer different from the hierarchical layer among the plurality of hierarchical layers.

8. The decoder according to claim 1, wherein
a size of the intermediate feature map is equal to a size of a feature map having a smallest size among the plurality of feature maps generated in the plurality of hierarchical layers, and
when the first method is selected for the at least one hierarchical layer, the circuitry, in operation, enlarges the size of the intermediate feature map to a size of a feature map generated in the at least one hierarchical layer.

9. The decoder according to claim 1, wherein
a size of the intermediate feature map is equal to a size of a feature map having a largest size among the plurality of feature maps generated in the plurality of hierarchical layers, and
when the first method is selected for the at least one hierarchical layer, the circuitry, in operation, reduces the size of the intermediate feature map to a size of a feature map generated in the at least one hierarchical layer.

10. The decoder according to claim 1, wherein when the first method is selected for the at least one hierarchical layer, the circuitry, in operation, generates the plurality of feature maps whose number is larger than a number of the plurality of intermediate feature maps by performing convolution processing on the plurality of intermediate feature maps.

11. The decoder according to claim 1, wherein when the first method is selected for the at least one hierarchical layer, the circuitry, in operation, generates the plurality of feature maps whose number is smaller than a number of the plurality of intermediate feature maps by extracting two or more intermediate feature maps corresponding to the at least one hierarchical layer from the plurality of intermediate feature maps.

12. The decoder according to claim 1, wherein the circuitry, in operation,
selects any of the first method and the second method for each hierarchical layer of the plurality of hierarchical layers, and
a number of the plurality of intermediate feature maps is smaller as a number of hierarchical layers for selecting the second method among the plurality of hierarchical layers is larger.

13. The decoder according to claim 1, wherein the circuitry, in operation,
selects any of the first method and the second method for each hierarchical layer of the plurality of hierarchical layers, and
when a size of an object of a detection target in the machine task is less than a threshold, or when local information is required in the machine task, the second method is selected for at least a hierarchical layer having a smallest size of a generated feature map among the plurality of hierarchical layers.

14. The decoder according to claim 1, wherein the circuitry, in operation,
selects any of the first method and the second method for each hierarchical layer of the plurality of hierarchical layers, and
when a size of an object of a detection target in the machine task is equal to or greater than a threshold, or when global information is required in the machine task, the second method is selected for at least a hierarchical layer having a largest size of a generated feature map among the plurality of hierarchical layers.

15. An encoder comprising:
circuitry; and
a memory connected to the circuitry,
wherein the circuitry, in operation,
generates, based on an input image of a processing target, a plurality of feature maps having different sizes for each hierarchical layer in a plurality of hierarchical layers included in a neural network for a machine task,
generates a plurality of intermediate feature maps having a uniform size based on a plurality of feature maps generated in the plurality of hierarchical layers,
generates an image based on the plurality of intermediate feature maps,
generates a bitstream by encoding the image, and
in generation of the intermediate feature maps, for at least one hierarchical layer of the plurality of hierarchical layers, selects any of:
a first method of generating the plurality of intermediate feature maps using the plurality of feature maps generated in the at least one hierarchical layer, and
a second method of generating the plurality of intermediate feature maps without using the plurality of feature maps generated in the at least one hierarchical layer.

16. The encoder according to claim 15, wherein the circuitry, in operation,
generates the bitstream including a parameter indicating which of the first method and the second method to have been selected for the at least one hierarchical layer.

17. The encoder according to claim 16, wherein the circuitry, in operation,
selects any of the first method and the second method for each hierarchical layer of the plurality of hierarchical layers,
the parameter includes a plurality of flags corresponding to the plurality of hierarchical layers, and
a value of each flag of the plurality of flags indicates which of the first method and the second method to have been selected for a corresponding hierarchical layer.

18. The encoder according to claim 16, wherein the circuitry, in operation,
selects any of the first method and the second method for each hierarchical layer of the plurality of hierarchical layers,
the parameter includes data of a plurality of bits corresponding to the plurality of hierarchical layers, and
a value of each bit of the plurality of bits indicates which of the first method and the second method to have been selected for a corresponding hierarchical layer.

19. The encoder according to claim 16, wherein the circuitry, in operation,
selects any of the first method and the second method for each hierarchical layer of the plurality of hierarchical layers,
a plurality of patterns are defined in advance regarding a combination of which of the first method and the second method to select for each hierarchical layer of the plurality of hierarchical layers,
one pattern is selected from among the plurality of patterns, and
the parameter includes information specifying the one pattern.

20. The encoder according to claim 16, wherein the circuitry, in operation,
stores the parameter in a supplemental enhancement information (SEI) region of the bitstream.

21. The encoder according to claim 15, wherein
a size of the intermediate feature map is equal to a size of a feature map having a smallest size among the plurality of feature maps generated in the plurality of hierarchical layers, and
when the first method is selected for the at least one hierarchical layer, the circuitry, in operation, reduces a size of a feature map generated in the at least one hierarchical layer to a size of the intermediate feature map.

22. The encoder according to claim 15, wherein
a size of the intermediate feature map is equal to a size of a feature map having a largest size among the plurality of feature maps generated in the plurality of hierarchical layers, and
when the first method is selected for the at least one hierarchical layer, the circuitry, in operation, enlarges a size of a feature map generated in the at least one hierarchical layer to a size of the intermediate feature map.

23. The encoder according to claim 15, wherein the circuitry, in operation,
selects any of the first method and the second method for each hierarchical layer of the plurality of hierarchical layers, and
a number of the plurality of intermediate feature maps is smaller as a number of hierarchical layers in which the second method among the plurality of hierarchical layers is selected is larger.

24. The encoder according to claim 15, wherein the circuitry, in operation,
selects any of the first method and the second method for each hierarchical layer of the plurality of hierarchical layers, and
when a size of an object of a detection target in the machine task is less than a threshold, or when local information is required in the machine task, the second method is selected for at least a hierarchical layer having a smallest size of a generated feature map among the plurality of hierarchical layers.

25. The encoder according to claim 15, wherein the circuitry, in operation,
selects any of the first method and the second method for each hierarchical layer of the plurality of hierarchical layers, and
when a size of an object of a detection target in the machine task is equal to or greater than a threshold, or when global information is required in the machine task, the second method is selected for at least a hierarchical layer having a largest size of a generated feature map among the plurality of hierarchical layers.

26. A decoding method, wherein
a decoder
generates an image by decoding a bitstream,
generates a plurality of intermediate feature maps having a uniform size based on the image,
generates, based on the plurality of intermediate feature maps, a plurality of feature maps having different sizes for each hierarchical layer in a plurality of hierarchical layers included in a neural network for a machine task, and
in generation of the feature maps, for at least one hierarchical layer of the plurality of hierarchical layers,
selects any of:
a first method of generating the plurality of feature maps of the at least one hierarchical layer using the plurality of intermediate feature maps, and
a second method of generating the plurality of feature maps of the at least one hierarchical layer without using the plurality of intermediate feature maps but using the plurality of feature maps generated in a hierarchical layer different from the at least one hierarchical layer of the plurality of hierarchical layers.

27. An encoding method, wherein
an encoder
generates, based on an input image of a processing target, a plurality of feature maps having different sizes for each hierarchical layer in a plurality of hierarchical layers included in a neural network for a machine task,
generates a plurality of intermediate feature maps having a uniform size based on a plurality of feature maps generated in the plurality of hierarchical layers,
generates an image based on the plurality of intermediate feature maps,
generates a bitstream by encoding the image, and
in generation of the intermediate feature maps, for at least one hierarchical layer of the plurality of hierarchical layers, selects any of:
a first method of generating the plurality of intermediate feature maps using the plurality of feature maps generated in the at least one hierarchical layer, and
a second method of generating the plurality of intermediate feature maps without using the plurality of feature maps generated in the at least one hierarchical layer.
